(19) United States
(12) Patent Application Publication
(10) Pub. No.: US 2024/0340639 A1
(43) Pub. Date: Oct. 10, 2024

(54) User Plane Integrity Protection in Dual Connectivity

(71) Applicant: Telefonaktiebolaget LM Ericsson (publ), Stockholm (SE)

(72) Inventors: Monica Wifvesson, Lund (SE); Prajwol Kumar Nakarmi, Solna (SE)

(21) Appl. No.: 18/682,515

(22) PCT Filed: Aug. 1, 2022
(86) PCT No.: PCT/EP2022/071532

§ 371 Date: Feb. 9, 2024

Related U.S. Application Data
(60) Provisional application No. 63/231,114, filed on Aug. 9, 2021.

(51) Int. Cl. H04W 12/033; H04W 12/106; H04W 76/15

(52) U.S. Cl. CPC H04W 12/033; H04W 12/106; H04W 76/15

(57) ABSTRACT

A wireless communication device (12) transmits, to a network node (18A-1, 18A-2, 18B) in an Evolved Packet System (10A), signaling (14A) indicating a capability (16) of the wireless communication device (12) to support user plane integrity protection over New Radio, NR, in Evolved Universal Terrestrial Radio Access-NR Dual Connectivity, EN-DC. Based on the indicated capability (16), a secondary gNB for EN-DC may activate or deactivate user plane integrity protection over NR in EN-DC.

### TECHNICAL FIELD

The present application relates generally to dual connectivity and relates more particularly to user plane integrity protection in dual connectivity.

### BACKGROUND

Multi-connectivity refers to the simultaneous connection of a wireless communication device to multiple different radio network nodes, or to multiple different groups of cells provided by different radio network nodes. The multiple different radio network nodes or cells may use the same radio access technology (e.g., both may use Evolved Universal Terrestrial Radio Access (E-UTRA) or both may use New Radio (NR)). Or, the multiple different radio network nodes or cells may use different radio access technologies, e.g., one may use E-UTRA and another may use NR.

One example of multi-connectivity is dual connectivity (DC) in which the wireless communication device is simultaneously connected to two different radio network nodes, or to two different groups of cells provided by two different radio network nodes. In this case, the wireless communication device may be configured with a so-called master cell group (MCG) and a secondary cell group (SCG), where the MCG includes one or more cells provided by the radio network node acting as a master node (MN) and the SCG includes one or more cells served by the radio network node acting as a secondary node (SN). The master node may be a master in the sense that it controls the secondary node and/or provides the control plane connection to the core network. For example, Evolved Universal Terrestrial Access (E-UTRA)-New Radio (NR) DC (EN-DC) refers to where the master node uses E-UTRA and the secondary node uses NR, whereas NR-E-UTRA (NE) refers to where the master node uses NR and the secondary node uses E-UTRA.

For example, in multi-connectivity operation, the wireless communication device with multiple receivers (Rx) and/or transmitters (Tx) may utilize radio resources amongst one or more radio access technologies (e.g., New Radio, NR, and/or E-UTRA) provided by multiple distinct schedulers connected via a non-ideal backhaul. Multi-radio dual connectivity (MR-DC) in this regard is a generalization of Intra-E-UTRA DC, where a multiple Rx/Tx wireless device may be configured to utilize resources provided by two different nodes connected via a non-ideal backhaul, one providing NR access and the other one providing either E-UTRA or NR access. One node acts as the master node (MN) and the other as a SN. E-UTRAN for instance supports MR-DC via E-UTRA-NR dual connectivity (EN-DC), in which a wireless device is connected to one eNB that acts as a MN and one en-gNB that acts as a secondary node (SN).

Securing communications in multi-connectivity proves challenging due to the multiple connectivity nature of those communications. For example, in known approaches to EN-DC, it is possible to encrypt user plane communications between the wireless communication device and the SgNB, but no mechanisms exist to integrity protect such user plane communications. Without integrity protection, user plane traffic remains vulnerable to tampering by attackers, which is a serious security issue.

### SUMMARY

Some embodiments herein introduce capability signaling for supporting integrity protection of user plane communications between a wireless communication device and a secondary node in dual connectivity, e.g., EN-DC. Based on this capability signaling, the secondary node can activate user plane integrity protection with the wireless communication device and advantageously guard against attackers tampering with the user plane traffic.

More particularly, embodiments herein include a method performed by a wireless communication device. The method comprises transmitting, to a network node in an Evolved Packet System, EPS, signaling indicating a capability of the wireless communication device to support user plane integrity protection over New Radio, NR, in Evolved Universal Terrestrial Radio Access-NR Dual Connectivity, EN-DC.

In some embodiments, the signaling is non-access stratum, NAS, signaling or Radio Resource Control, RRC, signaling.

In some embodiments, the network node is a Mobility Management Entity, MME, an eNB, or a master eNB in EN-DC.

In some embodiments, the signaling is transmitted in an Attach Request message, a Tracking Area Update message, a Security Mode Complete message, or a Service Request message. In other embodiments, the signaling is alternatively or additionally transmitted during, or as part of, a procedure for initial context setup, path switch, or handover.

In some embodiments, the method further comprises transmitting or receiving, over NR in EN-DC, user plane data that is integrity protected in accordance with the capability indicated by the signaling.

Other embodiments herein include a method performed by a network node. The method comprises transmitting or receiving signaling indicating a capability of a wireless communication device to support user plane integrity protection over NR in EN-DC.

In some embodiments, the signaling is non-access stratum, NAS, signaling or Radio Resource Control, RRC, signaling.

In some embodiments, the signaling is transmitted or received in an Attach Request message, a Tracking Area Update message, a Security Mode Complete message, or a Service Request message.

In some embodiments, the signaling is received during, or as part of a procedure for initial context setup, path switch, or handover. In other embodiments, the signaling is alternatively received during, or as part of a procedure for requesting the addition of an SgNB for EN-DC.

In some embodiments, the network node is in an Evolved Packet System, EPS.

In some embodiments, the network node is an eNB or a Mobility Management Entity, MME.

In some embodiments, said transmitting or receiving comprises receiving the signaling from the wireless communication device.

In some embodiments, said transmitting or receiving comprises receiving the signaling from another network node.

In some embodiments, said transmitting or receiving comprises transmitting the signaling to another network node. In some embodiments, the network node is in an EPS and the another network node is either in the EPS or in a 5G System, 5GS.

In some embodiments, said transmitting or receiving comprises transmitting the signaling, and the method further comprises creating the capability responsive to failure to receive NR security capabilities for the wireless communication device from a Mobility Management Entity, MME.

In some embodiments, the network node is a secondary gNB for EN-DC, and the method further comprises activating or deactivating user plane integrity protection over NR in EN-DC based on the capability indicated by the signaling. In some embodiments, said activating or deactivating is also based on a user plane integrity protection policy received from a master eNB in EN-DC.

Other embodiments herein include a wireless communication device. The wireless communication device comprises communication circuitry and processing circuitry. The processing circuitry is configured to transmit, to a network node in an Evolved Packet System, EPS, signaling indicating a capability of the wireless communication device to support user plane integrity protection over New Radio, NR, in Evolved Universal Terrestrial Radio Access-NR Dual Connectivity, EN-DC.

In some embodiments, the processing circuitry is configured to perform the steps described above for a wireless communication device.

Other embodiments herein include a network node. The network node comprises communication circuitry and processing circuitry. The processing circuitry is configured to transmit or receive signaling indicating a capability of a wireless communication device to support user plane integrity protection over NR in EN-DC.

In some embodiments, the processing circuitry is configured to perform the steps described above for a network node.

Other embodiments herein include a computer program comprising instructions which, when executed by at least one processor of a wireless communication device, causes the wireless communication device to perform the steps described above for a wireless communication device. Other embodiments herein include a computer program comprising instructions which, when executed by at least one processor of a network node, causes the network node to perform the steps described above for a network node. In some embodiments, a carrier containing the computer program is one of an electronic signal, optical signal, radio signal, or computer readable storage medium.

Of course, the present disclosure is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of a wireless communication device capable of Evolved Universal Terrestrial Radio Access (E-UTRA)-New Radio (NR) Dual Connectivity (EN-DC) according to some embodiments.

FIG. 2 is a block diagram of an offload architecture for EN-DC according to some embodiments.

FIG. 3 is a call flow diagram for signaling support of user plane integrity protection over NR in EN-DC via radio resource control (RRC) signaling according to some embodiments.

FIG. 4 is a call flow diagram for signaling support of user plane integrity protection over NR in EN-DC via an attach request according to some embodiments.

FIG. 5 is a block diagram of a UE network capability IE according to some embodiments.

FIG. 6 is a block diagram of a UE additional security capability IE according to some embodiments.

FIG. 7 is a block diagram of a UE network capability IE according to other embodiments.

FIG. 8 is a call flow diagram of SgNB encryption/decryption and integrity protection activation according to some embodiments.

FIG. 9 is a call flow diagram for local UP IP policy pre-configuration in the SgNB according to some embodiments.

FIG. 10 is a block diagram of a key hierarchy for the SgNB according to some embodiments.

FIG. 11 is a logic flow diagram of a method performed by a wireless communication device according to some embodiments.

FIG. 12 is a logic flow diagram of a method performed by a network node according to some embodiments.

FIG. 13 is a logic flow diagram of a method performed by a secondary eNB for DC in an EPS according to some embodiments.

FIG. 14 is a block diagram of a Dual Connectivity architecture with an SeNB according to some embodiments.

FIG. 15 is a call flow diagram of SeNB encryption/decryption and integrity protection activation according to some embodiments.

+

FIG. 16 is a call flow diagram for pre-configuration of a local UP IP protection policy in the SeNB according to some embodiments.

FIG. 17 is a block diagram of a wireless communication device according to some embodiments.

FIG. 18 is a block diagram of a network node according to some embodiments.

FIG. 19 is a block diagram of a communication system in accordance with some embodiments.

FIG. 20 is a block diagram of a user equipment according to some embodiments.

FIG. 21 is a block diagram of a network node according to some embodiments.

FIG. 22 is a block diagram of a host according to some embodiments.

FIG. 23 is a block diagram of a virtualization environment according to some embodiments.

FIG. 24 is a block diagram of a host communicating via a network node with a UE over a partially wireless connection in accordance with some embodiments.

### DETAILED DESCRIPTION

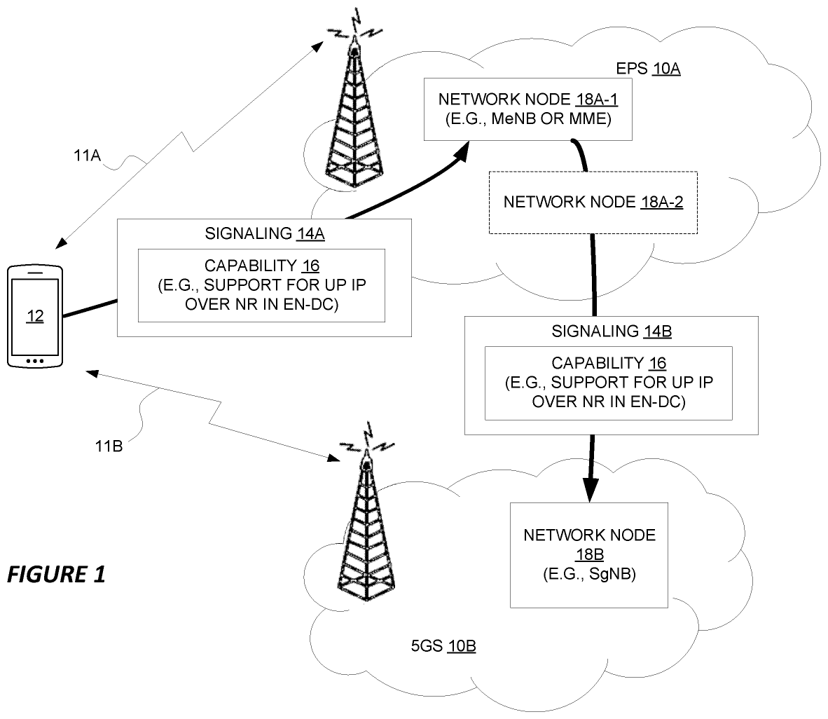

FIG. 1 shows a wireless communication device 12. In some embodiments, the wireless communication device 12 is capable of Evolved Universal Terrestrial Radio Access (E-UTRA)-New Radio (NR) Dual Connectivity (EN-DC). In EN-DC, the wireless communication device 12 is simultaneously connected to a master radio network node in an Evolved Packet System (EPS) 10A and to a secondary radio network node in a 5G System (5GS) 10B. The radio network node in the EPS 10A may for instance be referred to as a master eNodeB (MeNB) whereas the radio network node in the 5GS 10B may be referred to as a secondary gNodeB (SgNB). The wireless communication device 12 may correspondingly use Long Term Evolution (LTE) for the radio interface 11A with the EPS 10A and use NR for the radio interface 11B with the 5GS 10B.

The radio protocol architecture of the EPS 10A and the 5GS 10B is separated into a control plane (CP) and a user plane (UP). The user plane carries user traffic over one or more data radio bearers (DRBs), e.g., where user traffic includes end-to-end application layer data, such as voice packets or web content. The control plane carries signaling traffic over one or more signaling radio bearers (SRBs), e.g., where signaling traffic includes Radio Resource Control (RRC) signaling for configuring lower layers.

In this context, the wireless communication device 12 transmits signaling 14A that indicates a capability 16A of the wireless communication device 12. In particular, according to some embodiments, the capability 16A indicated by the signaling 14A is a capability of the wireless communication device 12 to support user plane (UP) integrity protection (IP) over NR in EN-DC.

In one such embodiment, the signaling 14A indicates that the wireless communication device 12 has the capability 16 to support user plane integrity protection over NR in EN-DC, e.g., via an optional information element (IE) in the signaling 14A that is present only if the wireless communication device 12 indeed has the capability 16 to support UP IP over NR in EN-DC. In other embodiments, the signaling 14A more broadly indicates whether or not the wireless communication device 12 has the capability 16 to support UP IP over NR in EN-DC, e.g., via an IE that has at least two different possible values, one for indicating that the wireless communication device 12 supports UP IP over NR in EN-DC and one for indicating that the wireless communication device 12 does not support UP IP over NR in EN-DC.

In some embodiments, support for UP IP over NR in EN-DC means that the wireless communication device 12 supports UP IP for DRB(s) established with the secondary radio network node (e.g., SgNB) in EN-DC. In this case, user plane traffic communicated over such DRB(s) is integrity protected.

In one or more embodiments, the wireless communication device 12 transmits the signaling 14A to a network node 18A-1 in the EPS 10A. In some embodiments, the network node 18A-1 is a radio network node, such as the master radio network node, e.g., MeNB. In this case, the signaling 14A may for example be RRC signaling and/or be transmitted during, or as part of, a procedure for initial context setup, path switch, or handover. In other embodiments, the network node 18A-1 is a Mobility Management Entity (MME). In this case, the signaling 14A may be Non-Access Stratum (NAS) signaling and/or be transmitted in an Attach Request message, a Tracking Area Update (TAU) message, a Security Mode Complete (SMC) message, or a Service Request message.

Regardless, based on the signaling 14A from the wireless communication device 12, the EPS 10A according to some embodiments transmits corresponding signaling 14B to the 5GS 10B. The EPS 10A may for example simply forward the received signaling 14A to the 5GS 10B as signaling 14B, e.g., such that signaling 14B is the same as signaling 14A. In other embodiments, though, the signaling 14B may differ from signaling 14A, e.g., be a different type of message and/or be communicated over a different type of interface. Nonetheless, the signaling 14B may still indicate a capability 16 of the wireless communication device 12 to support UP IP over NR in EN-DC.

Note that, in some embodiments, the network node 18A-1 that receives the signaling 14A from the wireless communication device 12 may directly transmit the corresponding signaling 14B to the 5GS 10B. In other embodiments, by contrast, the network node 18A-1 transmits the corresponding signaling 14B to the 5GS 10B via one or more other network nodes in the EPS 10A, e.g., network node 18A-2 in FIG. 1.

No matter, a network node 18B in the 5GS 10B receives the signaling 14B from the EPS 10A indicating the capability 16 of the wireless communication device 12. The network node 18B in the 5GS 10B may then activate or deactivate UP IP over NR in EN-DC based on the capability 16 indicated by the signaling 14B. The network node 18B may do so in accordance with a UP IP policy, which may be received from a network node in the EPS 10A or be a local policy that is pre-configured at the network node 18B. In embodiments involving such a local policy, for example, the local policy may control activation or deactivation of UP IP over NR in EN-DC if no UP IP protection policy is received from the MeNB in EN-DC.

Consider now additional details of some embodiments herein concerning EN-DC, where the wireless communication device 12 is exemplified as a user equipment (UE).

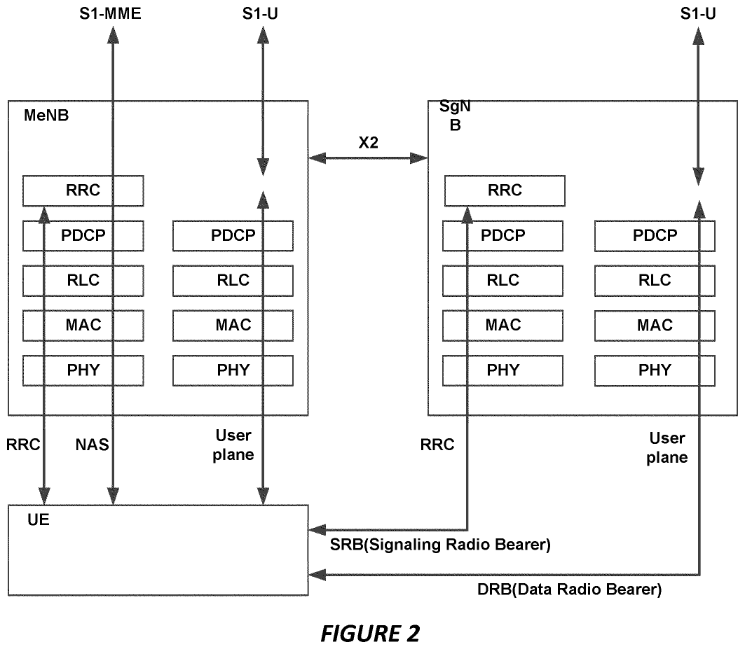

Some embodiments herein are applicable in a context described by Annex E.3 in TS 33.401 V16.3.0 and shown in FIG. 2. In this context, security functions support a UE that is simultaneously connected to eNB as master and gNB as secondary for EN-DC, e.g., in contrast to dual connectivity in E-UTRAN described in Annex E.2 in TS 33.401 V16.3.0. With dual connectivity between an MeNB and an SgNB (compared to between an MeNB and an SeNB), an RRC signalling connection is allowed between the UE and the SgNB. Such a RRC signalling connection shall be integrity protected in addition to being ciphered with the chosen ciphering algorithm. EPS bearers from the core network to the SgNB may be Split across the radio resources of both MeNB and SgNB (as well as being Non-Split and only using radio resources of the SgNB). For bearers whose Packet Data Convergence Protocol (PDCP) terminates in the MeNB, the security functions described for single connectivity mode shall be used, while for bearers whose PDCP terminates in the SgNB, the security algorithm given in subclause E.3.10.1 in TS 33.401 V16.3.0 with key derived as given in clause A. 19 in TS 33.401 V16.3.0 shall be used.

In this context, as an example of signaling 14A in FIG. 1, some embodiments herein provide a new UE capability for the UE to indicate support of UP IP over NR in EN-DC. This new capability may for example be named “UE capability to support UP IP over NR in EN-DC” which indicates that, or whether, the UE supports user plane integrity protection for DRB(s) or not, established with a SgNB in EN-DC.

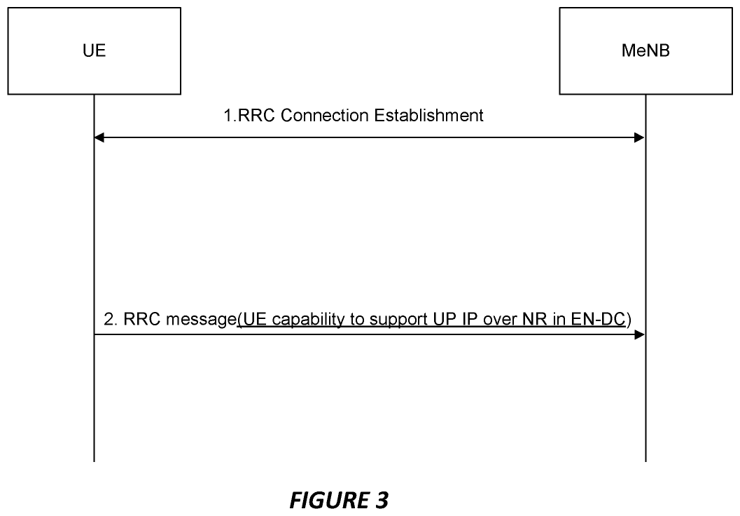

In some embodiments, the new indication sent from the UE to the network could be provided in RRC signaling from the UE to the Master eNB in EN-DC, as shown in FIG. 3. These embodiments thereby exemplify the case where the network node 18A-1 that receives the signaling 14A from the wireless communication device 12 in FIG. 1 is the MeNB. The Master eNB can then provide the indication to the 5GS 10B during dual connectivity or to another eNB during handovers or context transfers.

If this new indication sent from the UE to the network is provided in RRC signaling from the UE to the Master eNB in EN-DC, as an example of signaling 14A, then it could be implemented as the following options. In one option, the new indication is indicated in a new RRC message. In another option, the new indication is indicated in a new IE defined in an existing RRC message, e.g., in UECapabilityInformation. In yet another option, the new indication is indicated in an existing IE in an existing RRC message, but the existing IE is re-used for this new purpose, e.g., ueCapabilityRAT-ContainerUE IE may be used to contain the new indication.

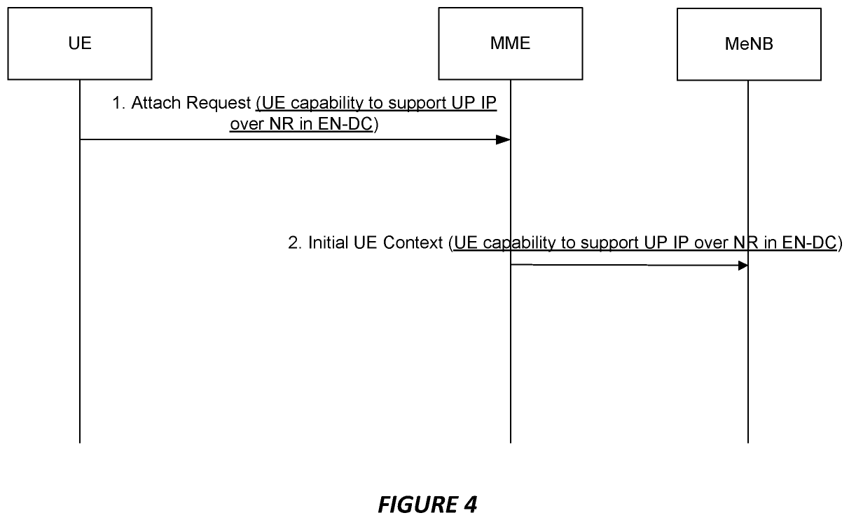

In other embodiments, this new indication sent from the UE to the EPS could be provided in NAS signaling from the UE to the MME. The MME can then provide the indication to an eNB, e.g., a Master eNB in procedures such as initial context setup or path switch or handover. FIG. 4 shows one example where the new indication is sent in an Attach Request to the MME, These embodiments thereby exemplify the case in FIG. 1 where the network node 18A-1 in the EPS that receives the signaling 14A from the wireless communication device 12 is the MME, and where the other network node 18A-2 in the EPS 10A via which the signaling 14B is transmitted to the 5GS 10B is the MeNB.

If this new indication sent from the UE to the network is provided in NAS signaling from the UE to the MME, as another example of signaling 14A, then it could be implemented as the following options.

As a first option, define a new IE in a NAS message (Attach Request or Tracking Area Update Request or Security Mode Complete or Service Request).

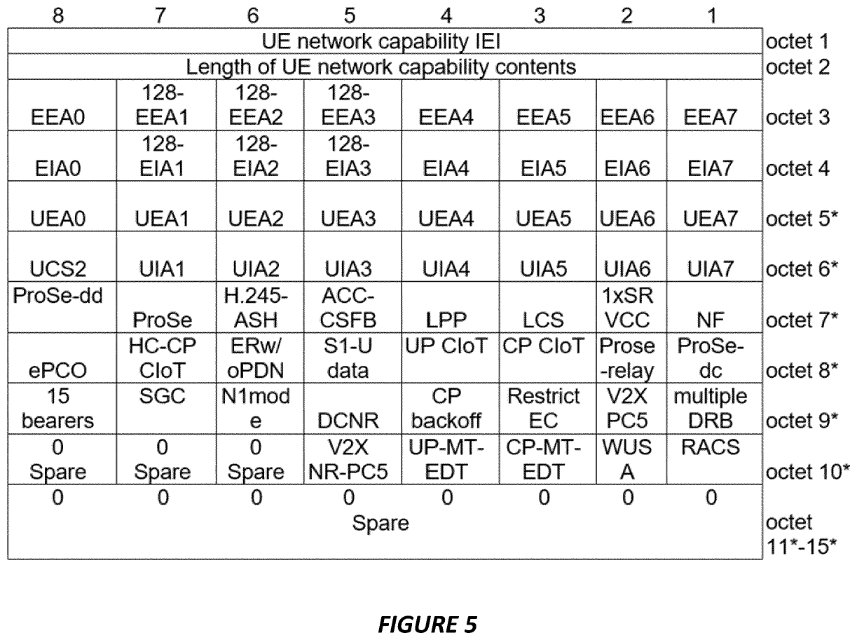

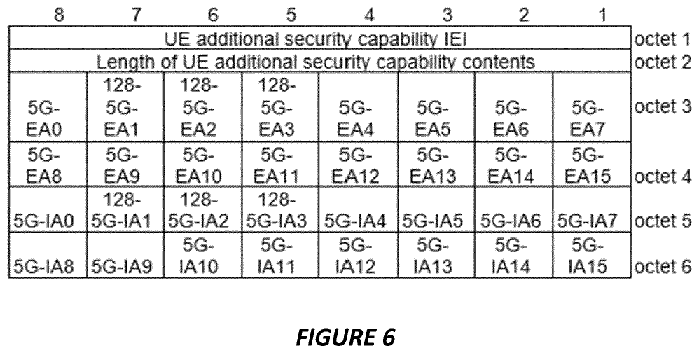

As a second option, reuse either UE Network Capability IE shown in FIG. 5 or UE additional security capability shown in FIG. 6.

Regarding UE Network Capability IE, e.g., as otherwise defined in clause 9.9.3.34 in TS 24.301 V17.3.0, the new indication may be signaled via a new spare bit in the UE Network Capability IE or any other existing IE in Attach Request or Tracking Area Update Request. Or, the new indication may be signaled by re-using any of the pre-allocated bit 128-EIA4-128-EIA6 in UE Network Capability IE defined in TS 24.301 V17.3.0, and allocate it as the new capability “UE capability to support UP IP over NR in EN-DC”. Note that EIA-7 is taken for indicating UE support over E-UTRA when connected to EPS.

Regarding UE additional security capability IE, e.g., as otherwise defined in clause 9.9.3.53 in TS 24.301 V17.3.0, the new indication may be signaled by re-using any of the pre-allocated bit in UE additional Security Capability IE defined in TS 24.301 V17.3.0, and allocating it as the new capability “UE capability to support UP IP over NR in EN-DC”.

Note, though, that in these embodiments the MeNB may not receive the UE NR security capabilities from the MME, if the MME is a legacy MME. Indeed, in Rel-15, it was specified that:

If the MeNB that does not have the UE NR security capabilities then it shall create them as follows: set the support of NEA0, 128-NEA1, 128-NEA2, 128-NEA3, 128-NIA1, 128-NIA2, 128-NIA3 to the same as EEA0, 128-EEA1, 128-EEA2, 128-EEA3, 128-EIA1, 128-EIA2, 128-EIA3 respectively; and set the rest of the bits to 0. This mapping of E-UTRAN security algorithms support to NR security algorithms support means that, for the purposes of dual connectivity to SgNB, the UE shall have the same support for 128-NEA1 as 128-EEA1, 128-NEA2 as 128-EEA2, 128-NEA3 as 128-EEA3, 128-NIA1 as 128-EIA1, 128-NIA2 as 128-EIA2 and 128-NIA3 as 128-EIA3.

According to some embodiments, then, the MeNB may re-create the capability according to one of the following options.

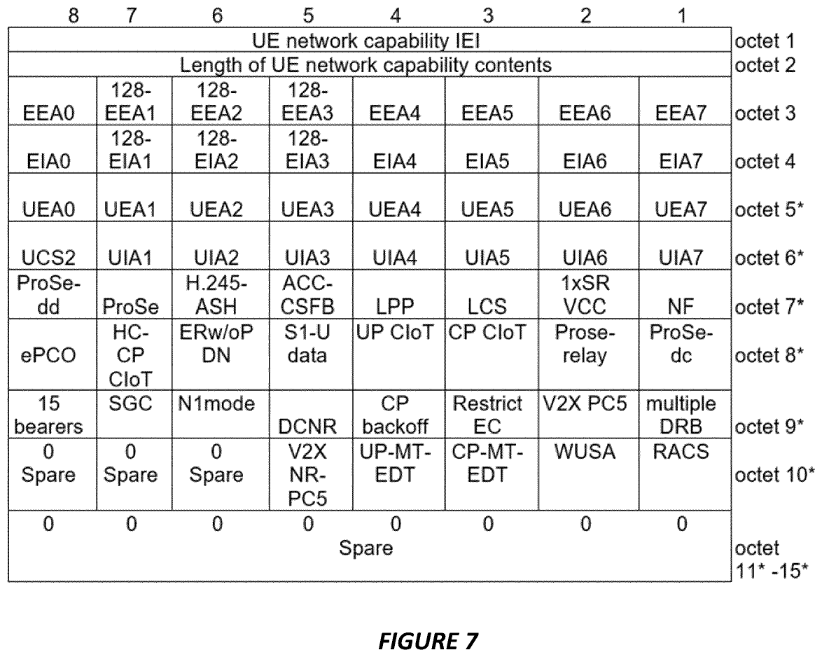

As a first option, Bit 128-EIA4 in UE Network Capability IE, shown in FIG. 7 and otherwise defined in TS 24.301 V17.3.0, could be taken and allocated as the new capability “UE capability to support UP IP over NR in EN-DC”.

As a second option, Bit 128-EIA5 in UE Network Capability IE, shown in FIG. 7 and otherwise defined in TS 24.301 V17.3.0, could be taken and allocated as the new capability “UE capability to support UP IP over NR in EN-DC”.

As a third option, Bit 128-EIA6 in UE Network Capability IE, shown in FIG. 7 and otherwise defined in TS 24.301 V17.3.0, could be taken and allocated as the new capability “UE capability to support UP IP over NR in EN-DC”.

Note that EIA-7 is now already taken for indicating UE support over E-UTRA when connected to EPS.

If the MeNB does not receive the UE NR security capabilities from the core network, then the MeNB can create the UE NR security capabilities as described above, i.e., MeNB could map bit 128-EIA4 to bit 128-NIA4.

If the MeNB does not receive the UE NR security capabilities from the core network, then the MeNB can create the UE NR security capabilities as described above, i.e., MeNB could map bit 128-EIA5 to bit 128-NIA5.

If the MeNB does not receive the UE NR security capabilities from the core network, then the MeNB can create the UE NR security capabilities as described above, i.e., MeNB could map bit 128-EIA6 to bit 128-NIA6.

No matter how the wireless communication device 12 signals its capability 16 to the EPS 10A, e.g., for reception by MeNB, consider now some additional details according to some embodiments.

### Embodiment #1

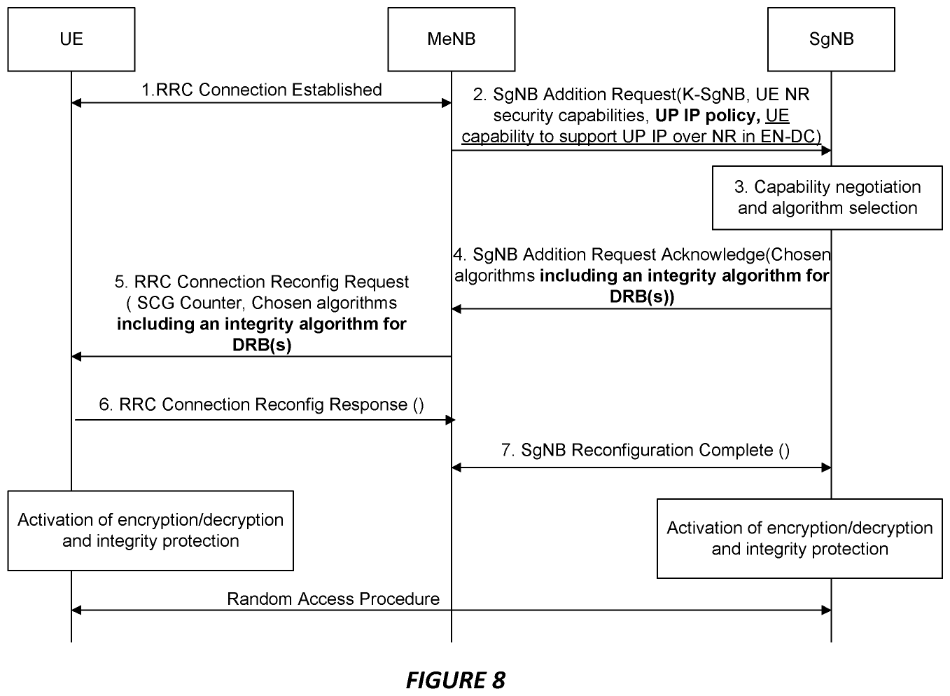

FIG. 8 shows SgNB activation of UP IP for DRB(s) with a UE according to some embodiments.

Step 1. The UE and the MeNB establish the RRC connection.

Step 2. Before the MeNB decides to use dual connectivity for some DRB(s) and/or an SRB with the SgNB, the MeNB shall check whether the UE has NR capability and is authorized to access NR. The MeNB sends SgNB Addition Request to the SgNB over the X2-C to negotiate the available resources, configuration, and algorithms at the SgNB. The MeNB computes and delivers the S-K_{gNB} to the SgNB if a new key is needed. The UE NR security capability shall also be sent to SgNB.

The MeNB provides and forwards the UP IP policy received from other entities to the SgNB. The UP IP policy is set to indicate whether either user plane integrity protection is “required”, “preferred” or “not needed”.

The MeNB provides and forwards a new UE capability to support UP IP over NR when gNB is acting as Secondary gNB in EN-DC i.e. “UE capability to support UP IP over NR in EN-DC” which the MeNB received from the core network, to the SgNB. This is an example of the signaling 14B in FIG. 1, for indicating the capability 16.

Step 3. The SgNB allocates the necessary resources and chooses the ciphering algorithm for the DRB(s) and SRB and integrity algorithm if an SRB is to be established which has the highest priority from its configured list and is also present in the UE NR security capability. If a new S-KgNB was delivered to the SgNB, then the SgNB calculates K_{sgNB-UP-enc} as well as K_{SqNB-RC-int} and K_{gNB-RRC-enc} if an SRB is to be established.

The SgNB determines to activate user plane integrity protection based on: the UP IP policy received from the MeNB, when the UP IP policy is set to either “required” or “preferred”; together with the received UE capability “UE capability to support UP IP over NR in EN-DC”.

If both UP IP policy and UE capability “UE capability to support UP IP over NR in EN-DC” are received from the MeNB and the UP IP policy is set to “required” and the UE capability “UE capability to support UP IP over NR in EN-DC” indicates that UE supports UP IP over NR in EN-DC, then the SgNB shall activate UP IP with the UE and select an algorithm for integrity protection to be used for data radio bearer(s) (DRB) and indicate the selected algorithm in step 4 to the MeNB.

If both UP IP policy and UE capability “UE capability to support UP IP over NR in EN-DC” are received from the MeNB and the UP IP policy is set to “preferred” and the UE capability “UE capability to support UP IP over NR in EN-DC” indicates that UE supports UP IP over NR in EN-DC, then the SgNB may decide to activate UP IP with the UE if possible and select an algorithm for integrity protection to be used for data radio bearer(s) (DRB) and indicate the selected algorithm in step 4 to the MeNB.

If both UP IP policy and UE capability “UE capability to support UP IP over NR in EN-DC”are received from the MeNB and the UP IP policy is set to “not needed” then the SgNB shall not activate UP IP with the UE even if the UE capability “UE capability to support UP IP over NR in EN-DC” indicates that UE supports UP IP over NR in EN-DC.

Step 4. The SgNB sends SgNB Addition Request Acknowledge to the MeNB indicating availability of requested resources and the identifiers for the selected algorithm(s) to serve the requested DRBs and/or SRB for the UE. The selected algorithms include the algorithm for integrity protection to be used with DRB(s) established with UE.

Step 5. The MeNB sends the RRC Connection Reconfiguration Request to the UE instructing it to configure the new DRBs and/or SRB for the SgNB. The MeNB shall include the SCG Counter parameter to indicate that the UE shall compute the S-K_{gNB} for the SgNB if a new key is needed. The MeNB forwards the UE configuration parameters (which contains the algorithm identifier(s) received from the SgNB in step 4) to the UE (see section E.3.4.3 in TS 33.401 V16.3.0, for further details). The selected algorithms include the algorithm for integrity protection too be used with DRB(s) established with UE.

Since the message is sent over the RRC connection between the MeNB and the UE, it is integrity protected using the K_{RRCint} of the MeNB. Hence the Secondary Cell Group (SCG) Counter cannot be tampered with, and the UE can assume that it is fresh.

Step 6. The UE accepts the RRC Connection Reconfiguration Command. The UE shall compute the S-K_{gNB} for the SgNB if an SCG Counter parameter was included. The UE shall also compute K_{SqNB-UP-enc} as well as K_{SqNB-RRC-int} and K_{SqNB-RC-enc} for the associated assigned DRBs and/or SRB. The UE sends the RRC Reconfiguration Complete to the MeNB. The UE activates the chosen encryption/decryption and integrity protection at this point.

Step 7. MeNB sends SgNB Reconfiguration Complete to the SgNB over the X2-C to inform the SgNB of the configuration result. On receipt of this message, SgNB may activate the chosen encryption/decryption and integrity protection with UE. If SgNB does not activate encryption/decryption and integrity protection with the UE at this stage, SgNB shall activate encryption/decryption and integrity protection upon receiving the Random Access request from the UE.

### Embodiment #2

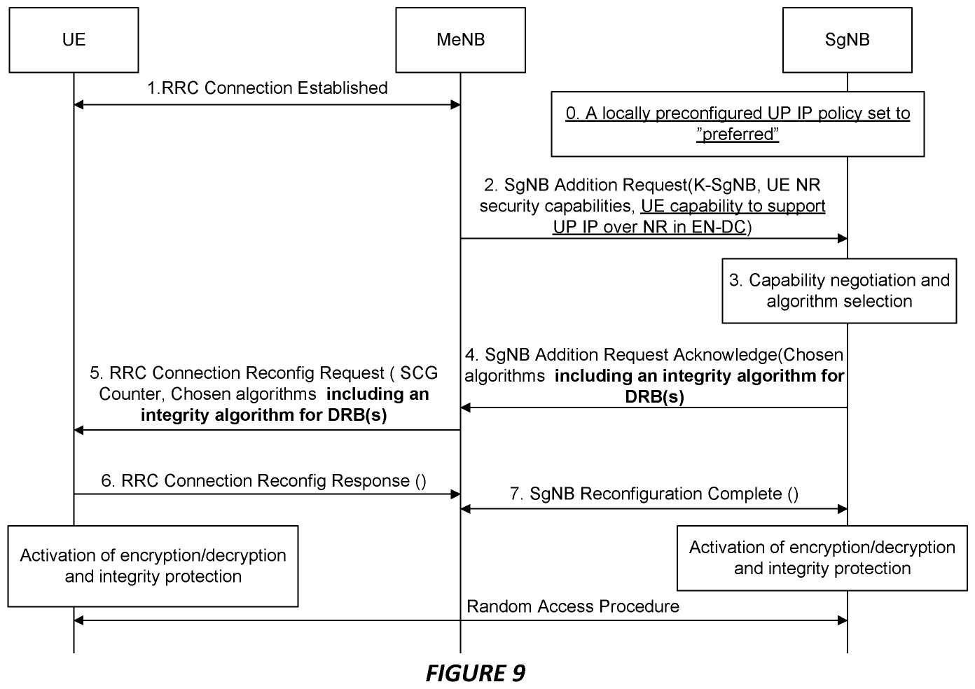

FIG. 9 shows local UP IP policy pre-configured in the SgNB according to some embodiments.

In these embodiments, the SgNB is preconfigured in step 0 of FIG. 9 with a local UP IP policy set to “preferred” by the operator.

If the SgNB does not receive any UP IP policy from the MeNB in step 2 in FIG. 9, then the locally configured UP IP policy shall be used by the SgNB in order to determine whether to activate user plane integrity protection or not. The decision is based on the reception of the UE capability “UE capability to support UP IP over NR in EN-DC”, and if the UE capability “UE capability to support UP IP over NR in EN-DC” indicates that UE supports UP IP over NR in EN-DC.

If this UE capability “UE capability to support UP IP over NR in EN-DC” is received from the MeNB and if the UE capability “UE capability to support UP IP over NR in EN-DC” indicates that UE supports UP IP over NR in EN-DC, then the SgNB activates user plane integrity protection and selects an algorithm for integrity protection and indicates the selected algorithm in step 4 to the MeNB.

If the UE capability “UE capability to support UP IP over NR in EN-DC” is not received from the MeNB then the SgNB does not activate user plane integrity protection.

More particularly, the steps in FIG. 9 include:

Step 0. In this embodiment, the SgNB is preconfigured in step 0 in FIG. 9 with a local UP IP policy set to “preferred”, “required” or “not needed” by the operator. Most likely it is set to ‘preferred “.

Step 1. The UE and the MeNB establish the RRC connection.

Step 2. Before the MeNB decides to use dual connectivity for some DRB(s) and/or an SRB with the SgNB, the MeNB shall check whether the UE has NR capability and is authorized to access NR. The MeNB sends SgNB Addition Request to the SgNB over the X2-C to negotiate the available resources, configuration, and algorithms at the SgNB. The MeNB computes and delivers the S-K_{gNB} to the SgNB if a new key is needed. The UE NR security capability shall also be sent to SgNB.

A new UE capability to support UP IP over NR when gNB is acting as Secondary gNB in EN-DC i.e. “UE capability to support UP IP over NR in EN-DC” which the MeNB received from the core network, is forwarded to the SgNB. This is an example of the signaling 14B in FIG. 1, for indicating the capability 16.

If the SgNB does not receive any UP IP policy from the MeNB in step 2 in FIG. 9, then the locally configured UP IP policy shall be used by the SgNB in order to determine whether to activate user plane integrity protection or not. The decision is based on the reception of the UE capability “UE capability to support UP IP over NR in EN-DC” and if the UE capability “UE capability to support UP IP over NR in EN-DC” indicates that UE supports UP IP over NR in EN-DC.

Step 3. The SgNB allocates the necessary resources and chooses the ciphering algorithm for the DRB(s) and SRB and integrity algorithm if an SRB is to be established which has the highest priority from its configured list and is also present in the UE NR security capability. If a new S-KgNB was delivered to the SgNB, then the SgNB calculates K_{sgNB-UP-enc} as well as K_{SqNB-RRC-int} and K_{sgNB-RC-enc} if an SRB is to be established.

The SgNB determines to activate user plane integrity protection based on: the locally configured UP IP policy in the Secondary gNB (SgNB), when the UP IP policy is set to “preferred”; together with the received UE capability “UE capability to support UP IP over NR in EN-DC” (if the UE capability “UE capability to support UP IP over NR in EN-DC” indicates that UE supports UP IP over NR in EN-DC).

If the UE capability “UE capability to support UP IP over NR in EN-DC” is received from the MeNB and if the UE capability “UE capability to support UP IP over NR in EN-DC” indicates that UE supports UP IP over NR in EN-DC, and the locally preconfigured UP IP policy is set to “preferred”, then the SgNB may activate UP IP with the UE. The SgNB select an algorithm for integrity protection to be used for data radio bearer(s) (DRB) and indicates the selected algorithm in step 4 to the MeNB.

Step 4. The SgNB sends SgNB Addition Request Acknowledge to the MeNB indicating availability of requested resources and the identifiers for the selected algorithm(s) to serve the requested DRBs and/or SRB for the UE. The selected algorithms include the algorithm for integrity protection too be used with DRB(s) established with UE.

Step 5. The MeNB sends the RRC Connection Reconfiguration Request to the UE instructing it to configure the new DRBs and/or SRB for the SgNB. The MeNB shall include the SCG Counter parameter to indicate that the UE shall compute the S-K_{gNB} for the SgNB if a new key is needed. The MeNB forwards the UE configuration parameters (which contains the algorithm identifier(s) received from the SgNB in step 4) to the UE (see section E.3.4.3 in TS 33.401 V16.3.0, for further details). The selected algorithms include the algorithm for integrity protection too be used with DRB(s) established with UE.

Since the message is sent over the RRC connection between the MeNB and the UE, it is integrity protected using the K_{RRCint} of the MeNB. Hence the SCG Counter cannot be tampered with, and the UE can assume that it is fresh.

Step 6. The UE accepts the RRC Connection Reconfiguration Command. The UE shall compute the S-K_{gNB} for the SgNB if an SCG Counter parameter was included. The UE shall also compute K_{SgNB-UP-enc} as well as K_{sgNB-RRC-int} and K_{SgNB-RRC-enc} for the associated assigned DRBs and/or SRB. The UE sends the RRC Reconfiguration Complete to the MeNB. The UE activates the chosen encryption/decryption and integrity protection at this point.

Step 7. MeNB sends SgNB Reconfiguration Complete to the SgNB over the X2-C to inform the SgNB of the configuration result. On receipt of this message, SgNB may activate the chosen encryption/decryption and integrity protection with UE. If SgNB does not activate encryption/decryption and integrity protection with the UE at this stage, SgNB shall activate encryption/decryption and integrity protection upon receiving the Random Access request from the UE.

Some EN-DC embodiments herein are implemented in the context described below. When the MeNB establishes security between an SgNB and the UE for the first time for a given Access Stratum (AS) security context shared between the MeNB and the UE, the MeNB generates the S-K_{gNB} (exactly as it would generate an S-K_{eNB}) for the SgNB and sends it to the SgNB over the X2-C. The SCG Counter is also used as freshness input into S-K_{gNB} derivations as described in the clause E.2.4 in TS 33.401 V16.3.0, and guarantees, together with the other provisions in the present clause E in TS 33.401 V16.3.0, that the integrity and ciphering keys used at the SgNB derived from the same S-K_{gNB} are not re-used with the same input parameters to avoid in key-stream re-use and provide replay protection. The MeNB sends the value of the SCG Counter to the UE over the LTE RRC signalling path when it is required to generate a new S-K_{gNB}.

The communication established between the SgNB and the UE is protected at the PDCP layer using the SgNB Secondary Cell security context, or SgNB SC security context for short. The SgNB SC security context includes S-K_{gNB}, the key used as input to the UP confidentiality algorithm, K_{sgNB-UP-enc}, the key used as the input to the RRC confidentiality algorithm, K_{SgNB-RRC-enc}, the key used as the input for the RRC integrity algorithm, K_{SgNB-RRC-int}, the identifiers of the selected cryptographic algorithms and counters used for replay protection. The UE and the SgNB derive the integrity and ciphering keys from the S-K_{gNB} as described in clause A. 19, cf. also E.3.4.2 in TS 33.401 V16.3.0.

Addition and modification of DRBs and/or SRB in SgNB

The S-K_{eNB} that is used for dual connectivity between eNBs (see subclause E.2.3 of TS 33.401 V16.3.0) is also used as the root for the security context at the SgNB. When used in the contexts of dual connectivity with an SgNB, the key shall be called an S-K_{gNB}, i.e., the MeNB generates and forwards an S-K_{gNB} to the SgNB during the SgNB Addition procedure or SgNB Modification procedure requiring key update.

Similarly, the MeNB handles the SCG Counter due to interactions with an SgNB as described in subclause E.2.2 of TS 33.401 V16.3.0, for interactions with SeNBs, i.e., this is a single shared SCG Counter for SeNBs and SgNBs and provides the same value of SCG Counter used to the UE and ensure that fresh radio bearer identities are used or the S-K_{gNB} is refreshed.

When the SgNB receives an S-K_{gNB} in an SgNB Addition/Modification procedure, the SgNB shall derive and store K_{SgNB-UP-enc} as well as K_{sgNB-RRC-int} and K_{sgNB-RRC-enc} if an SRB is to be added as described in subclause E.3.4.2 in TS 33.401 V16.3.0 from the received S-_{KgNB}. These freshly derived keys are then used to protect all the radio bearer(s) that use the PDCP of the SgNB. Any previous such keys shall be deleted. If all the keys were derived, then the S-K_{gNB} may be deleted.

If the UE receives a new SCG Counter in SgNB Addition/Modification procedure, then the UE shall derive a new S-K_{gNB} from this SCG Counter and use K_{SgNB-UP-enc}, K_{SgNB-RRC-int} and K_{SgNB-RRC-enc} derived from the new S-K_{gNB}, as the keys to protect all the radio bearer(s) using the PDCP of the SgNB. If all the keys were derived, then the S-K_{gNB} may be deleted in the UE.

When the SgNB Release procedure releases the last radio bearer on the SgNB, the SgNB and the UE shall delete the K_{SgNB-UPenc}, K_{SgNB-RRC-int} and K_{SgNB-RRC-enc}. The SgNB and UE shall also delete the S-K_{gNB}, if it was not deleted earlier.

Heretofore, UP integrity protection is not activated in SgNB when connected to EPC. Based on the signaling 14A, 14B herein, though, UP integrity protection may be activated in SgNB when connected to EPC.

Activation of encryption/decryption of DRBs and encryption/decryption/integrity protection of SRB

The dual connectivity procedure with activation of encryption/decryption of Split and/or Non-Split SgNB terminated DRB(s) (i.e., a DRB for which PDCP is located in the SgNB) and/or activation of encryption/decryption and integrity protection of an SgNB terminated SRB (i.e., an SRB for which PDCP is located in the SgNB) follows the steps outlined in Figure E.3.3-1 of TS 33.401 V16.3.0.

Derivation of Keys for Radio Bearers (RBs) with PDCP in the SgNB

### SCG Counter Maintenance

The same SCG Counter is used for both SeNB and SgNB and the handling for SgNBs follow the procedures for SeNB given in E.2.4.1 in TS 33.401 V16.3.0.

### Security Key Derivation

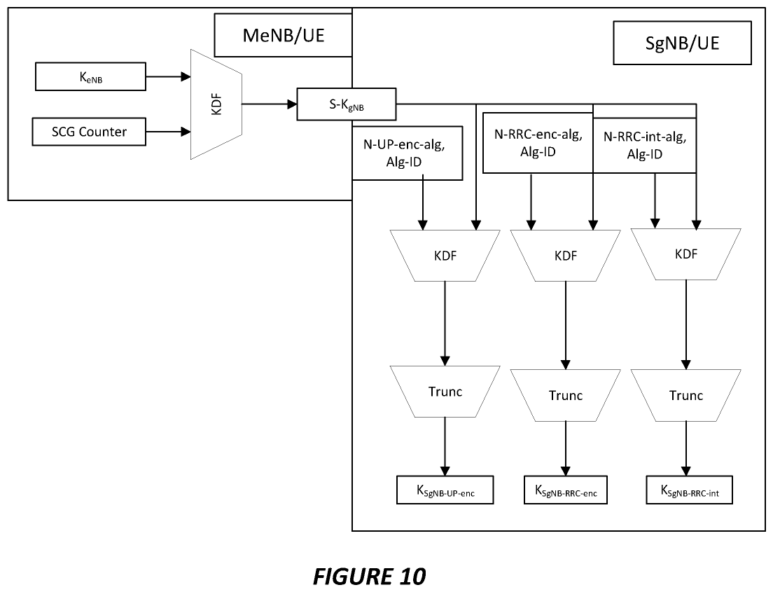

The UE and MeNB shall derive the security key S-K_{gNB} of the target SgNB as defined in Annex A.15 of TS 33.401 V16.3.0. K_{SqNB-UP-enc}, K_{SqNB-RC-int} and K_{SqNB-RRC-enc} are derived from the S-K_{gNB} both at the SgNB side and the UE side as shown on FIG. 10 using the function given in Annex A. 19 of TS 33.401 V16.3.0.

### Negotiation of Security Algorithms

The UE NR security capabilities shall be indicated to the network using a new IE so that the support of EPS and NR algorithms can evolve independently. The UE shall send the UE NR security capabilities to the MME in Attach Request and (when possibly changing MME) TAU Request. To enable the usage of NR EN-DC with an MME that does not understand the UE NR security capabilities in the new IE, such an MME will drop the UE NR security capabilities and never save them in its UE context. An eNB that does not receive the UE NR security capabilities shall use the E-UTRAN security capabilities algorithms to create the supported UE NR security capabilities (see Annex E.10.3.2 in TS 33.401 V16.3.0, for more details).

An MME that has the UE NR security capabilities shall send the UE NR security capabilities to the eNB in the S1-Initial Context Set-up message.

At S1-handover, if the target MME receives the UE NR security capabilities from the source MME, the target MME shall send the UE NR security capabilities to the target eNB in the S1-AP Handover Request.

At X2 handover, if the source eNB has the UE NR security capabilities, the source eNB shall send the UE NR security capabilities to the target eNB. These UE NR security capabilities should be the same as received from the MME on the S1 interface.

After a handover, it is possible that an eNB may have not received the UE NR security capabilities as the UE may have just been handed over from an eNB or MME that does not support the UE NR security capabilities. To overcome such a possible problem, the eNB shall create the UE NR security capabilities from the supported E-UTRAN security algorithms. To do this, the eNB shall use the mapping between the E-UTRAN security algorithms and NR security algorithms as per Annex E.3.10.2 in TS 33.401 V16.3.0. When adding SgNB while establishing an EN-DC connection, the MeNB shall send these created UE NR security capabilities to the SgNB. Other than for adding an SgNB, the created UE NR security capabilities shall not be sent from the MeNB.

A target eNB that has received the UE NR security capabilities during handover shall include the UE NR security capabilities in the S1-PATH SWITCH-REQUEST message.

If an MME does not receive the UE NR security capabilities in the S1-PATH-SWITCH-REQUEST message from the target eNB to which the UE is connected to, or if an MME becomes aware that the eNB doesn't know the UE NR security capabilities after an S1-handover, the MME should send the UE NR security capabilities to the target eNB via the PATH SWITCH REQUEST ACKNOWLEDGE message as specified in TS 36.413 V16.6.0, and the target eNB shall store the UE NR security capabilities in the UE context.

When establishing one or more DRBs and/or a SRB for a UE at the SgNB, as shown in Figure E.3.3-1 in TS 33.401 V16.3.0, the MeNB shall send the UE NR security capabilities associated with the UE in the SgNB Addition/Modification procedure. Upon receipt of this message, the SgNB shall identify the needed algorithm(s) with highest priority in the locally configured priority list of algorithms that is also present in the received UE NR security capabilities and include an indicator for the locally identified algorithm(s) in SgNB Addition/Modification Request Acknowledge.

The MeNB shall forward the indication to the UE during the RRCConnectionReconfiguration procedure that establishes the SgNB terminated DRBs and/or SgNB terminated SRB in the UE. The UE shall use the indicated encryption algorithms for the SgNB terminated DRBs and/or SgNB terminated SRB and the indicated integrity algorithm for the SgNB terminated SRB.

### Protection of the Traffic Between the UE and SgNB

The ciphering protection shall be applied between the UE and gNB at the PDCP layer. The integrity protection shall be applied to the SRB between the UE and gNB at the PDCP layer. In some embodiments, the integrity protection shall also be applied to the DRB between the UE and gNB at the PDCP layer.

The inputs to the integrity and ciphering algorithms are the same as the input for the algorithms in LTE. Both the UE and SgNB shall support the following algorithms described in Annex D of TS 33.501 V17.2.1.

NEA0 (which is the same as EEA0) for both RRC and UP confidentiality.

128-NEA1 (which is the same as 128-EEA1) for both RRC and UP confidentiality.

128-NEA2 (which is the same as 128-EEA2) for both RRC and UP confidentiality.

128-NIA1 (which is the same as 128-EIA1) for RRC integrity protection. 128-NIA2 (which is the same as 128-EIA2) for RRC integrity protection.

Both the UE and SgNB may support the following algorithms described in Annex D of TS 33.501 V17.2.1.

128-NEA3 (which is the same as 128-EEA3) for both RRC and UP confidentiality. 128-NIA3 (which is the same as 128-EIA3) for RRC integrity protection.

The UE and SgNB shall not use NIA0 (which is the same as EIA0) between the UE and SgNB.

UP integrity algorithms are supported by 5G-CN capable UEs, and, based on the signaling 14A, 14B herein, may be used when the UEs are accessing EPC.

Generally, then, some embodiments herein address the challenge that the SgNB in EN-DC heretofore supports and activates only user plane encryption, meaning that there is heretofore no mechanism for SgNB to activate user plane “integrity” protection. Without integrity protection, user plane traffic remains vulnerable to tampering by attackers, which is a serious security issue. Some embodiments herein accordingly described several enabling mechanisms so that the SgNB can activate user plane integrity protection with the UE. Advantageously, then, SgNB can activate user plane integrity protection in the UE and user plane packets sent between UE and SgNB can support and use user plane integrity protection. This is a significant security improvement because attacker cannot tamper the user plane packets without being noticed by receivers (SgNB or UE).

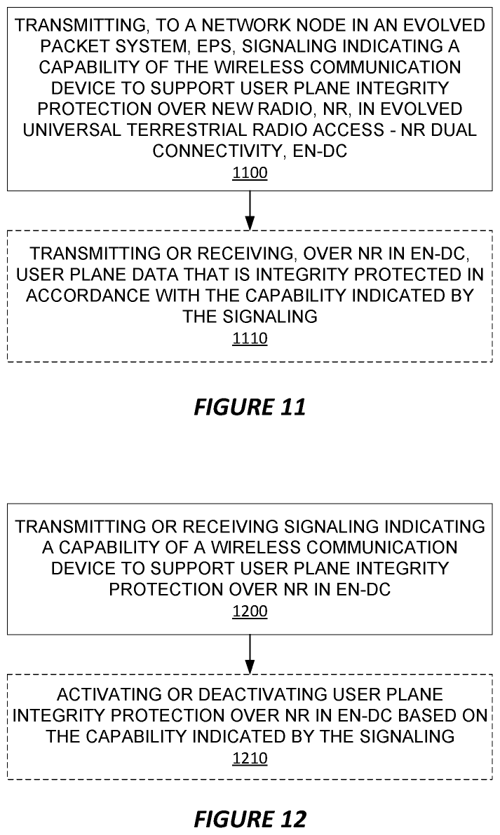

In view of the modifications and variations herein, FIG. 11 depicts a method performed by a wireless communication device 12 in accordance with particular embodiments. The method includes transmitting, to a network node 18A-1 in an EPS 10A, signaling 14A indicating a capability 16 of the wireless communication device 12 to support UP IP over NR in EN-DC (Block 1100). In some embodiments, the method also comprises transmitting or receiving, over NR in EN-DC, user plane data that is integrity protected in accordance with the capability 16 indicated by the signaling 14A (Block 1110).

In some embodiments, the signaling 14A indicates whether the wireless communication device 12 supports user plane integrity protection for a data radio bearer established with a secondary gNB, SgNB, in EN-DC.

In some embodiments, the signaling 14A is non-access stratum, NAS, signaling.

In some embodiments, the network node 18A-1 is a Mobility Management Entity, MME.

In some embodiments, the signaling 14A is transmitted in an Attach Request message, a Tracking Area Update message, a Security Mode Complete message, or a Service Request message.

In some embodiments, the signaling 14A is Radio Resource Control, RRC, signaling.

In some embodiments, the network node 18A-1 is an eNB.

In some embodiments, the network node 18A-1 is a master eNB in EN-DC.

In some embodiments, the signaling 14A is transmitted during, or as part of, a procedure for initial context setup, path switch, or handover.

FIG. 12 depicts a method performed by a network node in accordance with particular embodiments. The network node performing the method may for example be network node 18A-1, network node 18A-2, or network node 18B in FIG. 1. The method includes transmitting and/or receiving signaling 14A or 14B indicating a capability 16 of a wireless communication device 12 to support UP IP over NR in EN-DC (Block 1200).

In some embodiments, the signaling 14A or 14B indicates whether the wireless communication device 12 supports user plane integrity protection for a data radio bearer established with a secondary gNB, SgNB, in EN-DC.

In some embodiments, the network node is in an Evolved Packet System, EPS 10A.

In some embodiments, said transmitting or receiving comprises receiving the signaling 14A or 14B. In some embodiments, such as where the network node is network node 18A-1, the signaling 14A or 14B is signaling 14A received from the wireless communication device 12. In other embodiments, such as where the network node is network node 18B, the signaling 14A or 14B is signaling 14B received from another network node 18A-1 or 18A-2. In some embodiments, for example, the network node is network node 18A-2 in an EPS 10A and the another network node 18A-1 is also in the EPS 10A.

In some embodiments, said transmitting or receiving comprises transmitting the signaling 14A or 14B to another network node 18A-2 or 18B. In some embodiments, for example, the network node is network node 18A-1 in an EPS 10A and the another network node 18A-2 is also in the EPS 10A. In other embodiments, the network node is network node 18A-1 or 18A-2 in an EPS 10A and the another network node 18B is in a 5G System, 5GS 10B.

In some embodiments, the signaling 14A or 14B is non-access stratum, NAS, signaling.

In some embodiments, the network node is a Mobility Management Entity, MME.

In some embodiments, the signaling 14A or 14B is transmitted or received in an Attach Request message, a Tracking Area Update message, a Security Mode Complete message, or a Service Request message.

In some embodiments, the signaling 14A or 14B is Radio Resource Control, RRC, signaling.

In some embodiments, the network node is an eNB.

In some embodiments, the network node is a master eNB in EN-DC. In some embodiments, said transmitting or receiving comprises transmitting the signaling 14A or 14B. In some embodiments, the method further comprises creating the capability 16 responsive to failure to receive NR security capabilities for the wireless communication device 12 from a Mobility Management Entity, MME. In some embodiments, said creating comprises mapping Bit 128-EIA4, 128-EIA5, or 128-EIA6 in a UE Network Capability IE as said capability 16.

In some embodiments, the signaling 14A or 14B is received during, or as part of, a procedure for initial context setup, path switch, or handover.

In some embodiments, the signaling 14A or 14B is transmitted or received during, or as part of, a procedure for requesting the addition of an SgNB for EN-DC.

In some embodiments, the network node is a secondary gNB for EN-DC. In some embodiments, the method further comprises activating or deactivating user plane integrity protection over NR in EN-DC based on the capability 16 indicated by the signaling 14A or 14B. In some embodiments, said activating or deactivating is also based on a user plane integrity protection policy received from a master eNB in EN-DC. In some embodiments, said activating or deactivating is also based on a local policy that is pre-configured at the network node and that governs user plane integrity protection over NR in EN-DC. In some embodiments, the local policy controls activation or deactivation of user plane integrity protection over NR in EN-DC if no user plane integrity protection policy is received from a master eNB in EN-DC.

Where the method is implemented by network node 18A-1, for example, such involves receiving signaling 14A from the wireless communication device 12 and/or transmitting signaling 14B to network node 18A-2 or network node 18B.

Where the method is implemented by network node 18A-2, as another example, such involves receiving signaling 14B from network node 18A-1 and/or transmitting signaling 14B towards network node 18B.

Finally, where the method is implemented by network node 18B, such involves receiving signaling 14B from the EPS 10A. In these and other embodiments, then, the method may further include activating or deactivating user plane integrity protection over NR in EN-DC based on the capability 16 indicated by the signaling 14B (Block 1210). In this case, activating or deactivating may also be based on a user plane integrity protection policy received from a master eNB in EN-DC. Alternatively, activating or deactivating may also be based on a local policy that is pre-configured at the network node and that governs user plane integrity protection over NR in EN-DC, where the local policy controls activation or deactivation of user plane integrity protection over NR in EN-DC if no user plane integrity protection policy is received from a master eNB in EN-DC.

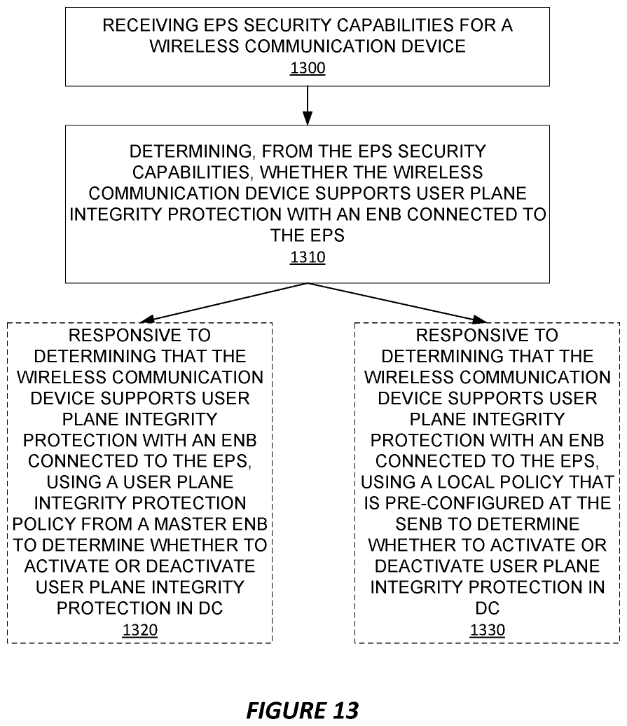

FIG. 13 depicts a method performed by a secondary eNB, SeNB, for Dual Connectivity, DC, in an Evolved Packet System, EPS 10A in accordance with particular embodiments. The method includes receiving EPS security capabilities for a wireless communication device 12 (Block 1300). In this case, the method also includes determining, from the EPS security capabilities, whether the wireless communication device 12 supports user plane integrity protection with an eNB connected to the EPS 10A (Block 1310). In this case, the method also includes, responsive to determining that the wireless communication device 12 supports user plane integrity protection with an eNB connected to the EPS 10A, using a user plane integrity protection policy from a master eNB to determine whether to activate or deactivate user plane integrity protection in DC. In other embodiments, the method also includes, responsive to determining that the wireless communication device 12 supports user plane integrity protection with an eNB connected to the EPS 10A, alternatively using a local policy that is pre-configured at the SeNB to determine whether to activate or deactivate user plane integrity protection in DC. In some embodiments, the local policy controls activation or deactivation of user plane integrity protection in DC if no user plane integrity protection policy is received from the master eNB in DC.

In some embodiments, said using comprises using a user plane integrity protection policy from a master eNB to determine whether to activate or deactivate user plane integrity protection in DC.

In some embodiments, said using comprises using a local policy that is pre-configured at the SeNB to determine whether to activate or deactivate user plane integrity protection in DC. In some embodiments, the local policy controls activation or deactivation of user plane integrity protection in DC if no user plane integrity protection policy is received from the master eNB in DC.

Consider now yet other embodiments herein that concern DC with multiple eNBs in the EPS 10A. Heretofore, the eNB in DC supports and activates only user plane encryption. There is heretofore no mechanism for eNB to activate user plane “integrity” protection. Without integrity protection, user plane traffic remains vulnerable to tampering by attackers, which is a serious security issue. Embodiments herein include several enabling mechanisms so that the eNB can activate user plane integrity protection with the UE. In particular, an eNB can activate user plane integrity protection in the UE and user plane packets sent between UE and eNB can support and use user plane integrity protection. This is a significant security improvement because attacker cannot tamper the user plane packets without being noticed by receivers (eNB or UE).

More particularly, Dual Connectivity architecture with an SeNB in EPS was specified in release-12.

For dual connectivity architecture, which hosts PDCP in MeNB, the security functions described for the single connectivity mode in TS 33.401 V16.3.0 are sufficient. The reason that they are sufficient, is that the end-point for the encryption remains in the MeNB. That is, from a security point of view, the PDCP packets are still processed in the same locations in the architecture; they have only travelled a different path via the SeNB.

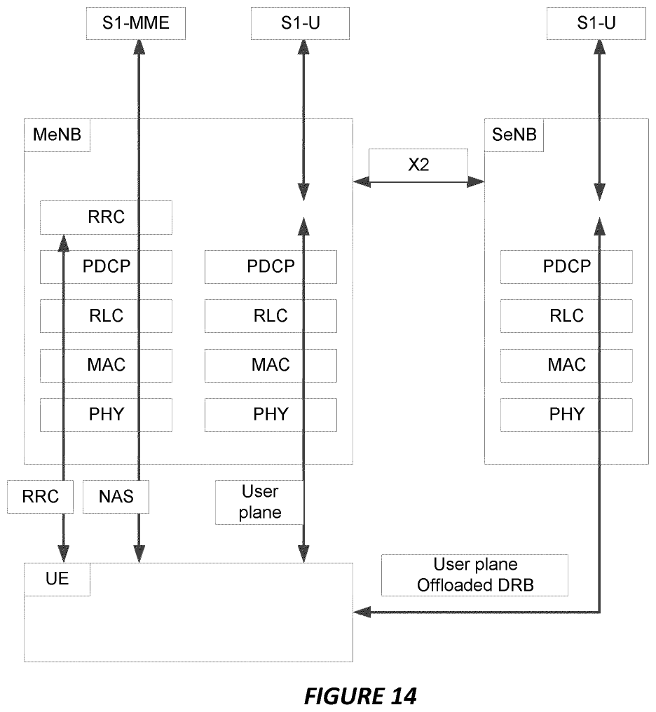

Some embodiments herein utilize dual connectivity between an MeNB and an SeNB with the architecture as shown in FIG. 14.

When the MeNB establishes security between an SeNB and the UE for the first time for a given AS security context shared between the MeNB and the UE, the MeNB generates the S-K_{eNB} for the SeNB and sends it to the SeNB over the X2-C. To generate the S-K_{eNB}, the MeNB associates a counter, called an SCG Counter, with the current AS security context. The SCG Counter is used as freshness input into S-K_{eNB} derivations as described in the clause E.2.4 in TS 33.401 V16.3.0, and guarantees together with the other provisions in the present clause E, that the K_{Upenc} derived from the same S-K_{eNB} is not re-used with the same input parameters as defined in Annex B of in TS 33.401 V16.3.0. The latter would result in key-stream re-use. The MeNB sends the value of the SCG Counter to the UE over the RRC signalling path when it is required to generate a new S-K_{eNB}.

The communication established between the SeNB and the UE is protected at the PDCP layer using the AS Secondary Cell security context, or AS SC security context for short. The AS SC security context includes parameters as the AS security context described in clause 7 of TS 33.401 V16.3.0, the S-K_{eNB} replaces the K_{eNB}. The UE and the SeNB derives the K_{Upenc} from the S-K_{eNB} as described in clause A.7, cf. also E.2.4.2 in TS 33.401 V16.3.0.

According to embodiments herein, it is assumed that EIA7 in the UE EPS security capability indicates that the UE supports user plane integrity protection with LTE eNB, i.e., “UE supports user plane integrity protection with LTE eNB”.

### Embodiment #3

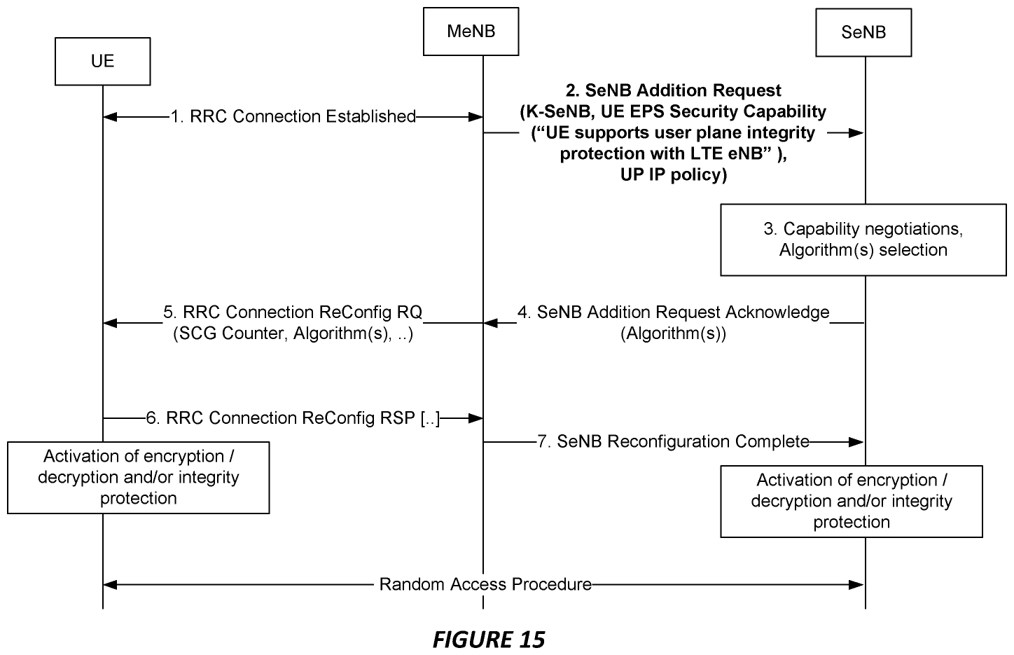

FIG. 15 shows SeNB activation of UP IP for DRB(s) with a UE according to other embodiments. In particular, FIG. 15 shows the mechanism for SeNB encryption/decryption and integrity protection activation according to some embodiments.

Step 1. The UE and the MeNB establish the RRC connection.

Step 2. The MeNB decides to offload the DRB(s) to the SeNB. The MeNB sends SeNB Addition Request to the SeNB over the X2-C to negotiate the available resources, configuration, and algorithms at the SeNB. When connected to EPC, the MeNB shall indicate to the SeNB the UP integrity protection policy and the corresponding E-RAB ID, if the UP integrity protection policy is received from other entities. The MeNB computes and delivers the S-K_{eNB} to the SeNB as necessary. UE EPS security capability should also be sent to SeNB.

Step 3. The SeNB allocates the necessary resources and chooses the ciphering algorithm which has the highest priority from its configured list and is also present in the UE EPS security capability. If EIA7 in the UE EPS security capabilities indicates that the UE supports user plane integrity protection with a eNB connected to EPS i.e. “UE supports user plane integrity protection with LTE eNB”, then the SeNB shall use the UP IP policy received from the MeNB to determine whether to activate or deactivate UP integrity protection.

Step 4. The SeNB sends SeNB Addition Request Acknowledge to the MeNB indicating availability of requested resources and the identifiers for the selected ciphering algorithm and integrity algorithm to serve the requested DRB for the UE.

Step 5. The MeNB sends the RRC Connection Reconfiguration Request to the UE instructing it to configure a new DRB for the SeNB. The MeNB shall include the SCG Counter parameter to indicate that the UE shall compute the S-K_{eNB} for the SeNB, K_{Upint} and the K_{Upenc} associated with the assigned bearer. The MeNB forwards the UE configuration parameters (which contains the algorithm identifier received from the SeNB in step 4) to the UE (see section E.2.4.3 for further details).

Since the message is sent over the RRC connection between the MeNB and the UE, it is integrity protected using the K_{RRCint} of the MeNB. Hence the SCG Counter cannot be tampered with, and the UE can assume that it is fresh.

Step 6. The UE accepts the RRC Connection Reconfiguration Command and shall compute the S-K_{eNB} for the SeNB. The UE shall also compute the K_{Upenc} and K_{Upint} for the associated assigned DRB on the SeNB. The UE sends the RRC Reconfiguration Complete to the MeNB. The UE activates encryption/decryption and integrity protection/no integrity protection once S-K_{eNB} and K_{Upenc} and K_{Upint} are derived.

Step 7. MeNB sends SeNB Reconfiguration Complete to the SeNB over the X2-C to inform SeNB configuration result. On receipt of this message, SeNB may activate encryption/decryption and integrity protection with UE. If SeNB does not activate encryption/decryption or integrity protection with the UE at this stage, SeNB shall activate encryption/decryption upon and integrity protection receiving the Random Access request from the UE.

### Embodiment #4

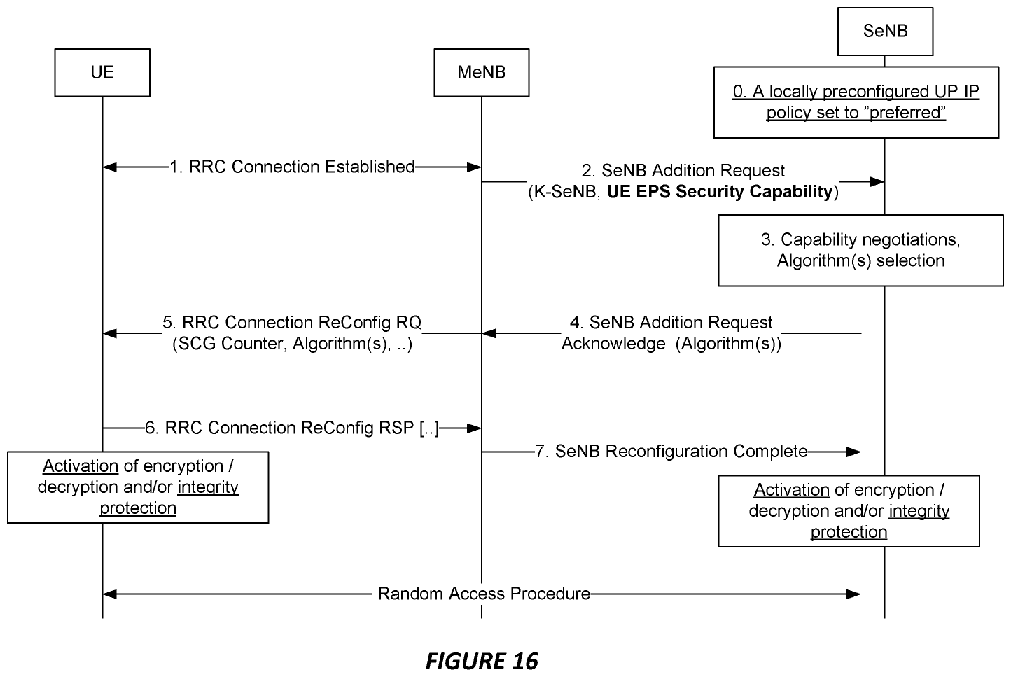

FIG. 16 shows local UP IP policy pre-configured in the SeNB according to some embodiments. In particular, in this embodiment, the SeNB is preconfigured in step 0 in FIG. 16 with a local UP IP policy set to “preferred” by the operator.

It is assumed that EIA7 in the UE EPS security capability indicates that the UE supports user plane integrity protection with LTE eNB, i.e., “UE supports user plane integrity protection with LTE eNB”.

If the SeNB does not receive any UP IP policy from the MeNB in step 2 in FIG. 16, then the locally configured UP IP policy shall be used by the SeNB in order to determine whether to activate user plane integrity protection or not. The decision is based on the reception of the UE capability “UE supports user plane integrity protection with LTE eNB”, and if the UE capability “UE supports user plane integrity protection with LTE eNB”, indicates that UE supports UP IP with a LTE eNB.

If this UE capability “UE supports user plane integrity protection with LTE eNB” is received from the MeNB, and if the UE capability “UE supports user plane integrity protection with LTE eNB” indicates that UE supports UP IP with a LTE eNB, then the SeNB activates user plane integrity protection and selects an algorithm for integrity protection and indicates the selected algorithm in step 4 to the MeNB.

If the UE capability “UE supports user plane integrity protection with LTE eNB” is not received from the MeNB then the SeNB does not activate user plane integrity protection.

More particularly, the steps of FIG. 16 are described as follows.

Step 0: SeNB is preconfigured with a local UP IP policy which is set to “preferred”. “required” or “not needed” by the operator. Most likely it is set to “preferred”.

Step 1. The UE and the MeNB establish the RRC connection.

Step 2. The MeNB decides to offload the DRB(s) to the SeNB. The MeNB sends SeNB Addition Request to the SeNB over the X2-C to negotiate the available resources, configuration, and algorithms at the SeNB. When connected to EPC, the MeNB shall indicate to the SeNB the UP integrity protection policy and the corresponding E-RAB ID, if the UP integrity protection policy is received from other entities. The MeNB computes and delivers the S-K_{eNB} to the SeNB as necessary. UE EPS security capability should also be sent to SeNB.

Step 3: The SeNB allocates the necessary resources and chooses the ciphering algorithm which has the highest priority from its configured list and is also present in the UE EPS security capability.

If EIA7 in the UE EPS security capabilities indicates that the UE supports user plane integrity protection, then the SeNB shall use the UP IP policy received from the MeNB to determine whether to activate or deactivate UP integrity protection. If the SeNB does not receive the UP IP policy from the MeNB, but the EIA7 in the UE EPS security capability indicates that the UE supports user plane integrity protection with LTE eNB, the SeNB shall use its locally configured UP integrity protection policy to activate or deactivate the UP integrity protection for all DRBs belonging to the E-RAB.

The SeNB determines to activate user plane integrity protection based on: the locally configured UP IP policy in the Secondary eNB (SeNB), when the UP IP policy is set to “preferred” or “required”; together with the received UE capability “UE supports user plane integrity protection with LTE eNB (if the UE capability “UE supports user plane integrity protection with LTE eNB” indicates that UE supports UP IP with LTE eNB).

The SeNB selects an algorithm for integrity protection to be used for data radio bearer(s) (DRB) and indicates the selected algorithm in step 4 to the MeNB.

Step 4. The SeNB sends SeNB Addition Request Acknowledge to the MeNB indicating availability of requested resources and the identifiers for the selected ciphering algorithm and integrity algorithm to serve the requested DRB for the UE.

Step 5. The MeNB sends the RRC Connection Reconfiguration Request to the UE instructing it to configure a new DRB for the SeNB. The MeNB shall include the SCG Counter parameter to indicate that the UE shall compute the S-K_{eNB} for the SeNB, K_{Upint} and the K_{Upenc} associated with the assigned bearer. The MeNB forwards the UE configuration parameters (which contains the algorithm identifier received from the SeNB in step 4) to the UE (see section E.2.4.3 for further details).

Since the message is sent over the RRC connection between the MeNB and the UE, it is integrity protected using the K_{RRCint} of the MeNB. Hence the SCG Counter cannot be tampered with, and the UE can assume that it is fresh.

Step 6. The UE accepts the RRC Connection Reconfiguration Command and shall compute the S-K_{eNB} for the SeNB. The UE shall also compute the K_{Upenc} and K_{Upint} for the associated assigned DRB on the SeNB. The UE sends the RRC Reconfiguration Complete to the MeNB. The UE activates encryption/decryption and integrity protection/no integrity protection once S-K_{eNB} and K_{Upenc} and K_{Upint} are derived.

Step 7. MeNB sends SeNB Reconfiguration Complete to the SeNB over the X2-C to inform SeNB configuration result. On receipt of this message, SeNB may activate encryption/decryption and integrity protection with UE. If SeNB does not activate encryption/decryption or integrity protection with the UE at this stage, SeNB shall activate encryption/decryption upon and integrity protection receiving the Random Access request from the UE.

Embodiments herein also include corresponding apparatuses. Embodiments herein for instance include a wireless communication device 12 configured to perform any of the steps of any of the embodiments described above for the wireless communication device 12.

Embodiments also include a wireless communication device 12 comprising processing circuitry and power supply circuitry. The processing circuitry is configured to perform any of the steps of any of the embodiments described above for the wireless communication device 12. The power supply circuitry is configured to supply power to the wireless communication device 12.

Embodiments further include a wireless communication device 12 comprising processing circuitry. The processing circuitry is configured to perform any of the steps of any of the embodiments described above for the wireless communication device 12. In some embodiments, the wireless communication device 12 further comprises communication circuitry.

Embodiments further include a wireless communication device 12 comprising processing circuitry and memory. The memory contains instructions executable by the processing circuitry whereby the wireless communication device 12 is configured to perform any of the steps of any of the embodiments described above for the wireless communication device 12.

Embodiments moreover include a user equipment (UE). The UE comprises an antenna configured to send and receive wireless signals. The UE also comprises radio front-end circuitry connected to the antenna and to processing circuitry, and configured to condition signals communicated between the antenna and the processing circuitry. The processing circuitry is configured to perform any of the steps of any of the embodiments described above for the wireless communication device 12. In some embodiments, the UE also comprises an input interface connected to the processing circuitry and configured to allow input of information into the UE to be processed by the processing circuitry. The UE may comprise an output interface connected to the processing circuitry and configured to output information from the UE that has been processed by the processing circuitry. The UE may also comprise a battery connected to the processing circuitry and configured to supply power to the UE.

Embodiments herein also include a network node 18A-1, 18A-2, 18B configured to perform any of the steps of any of the embodiments described above for the network node 18A-1, 18A-2, 18B.

Embodiments also include a network node 18A-1, 18A-2, 18B comprising processing circuitry and power supply circuitry. The processing circuitry is configured to perform any of the steps of any of the embodiments described above for the network node 18A-1, 18A-2, 18B. The power supply circuitry is configured to supply power to the network node 18A-1, 18A-2, 18B.

Embodiments further include a network node 18A-1, 18A-2, 18B comprising processing circuitry. The processing circuitry is configured to perform any of the steps of any of the embodiments described above for the network node 18A-1, 18A-2, 18B. In some embodiments, the network node 18A-1, 18A-2, 18B further comprises communication circuitry.

Embodiments further include a network node 18A-1, 18A-2, 18B comprising processing circuitry and memory. The memory contains instructions executable by the processing circuitry whereby the network node 18A-1, 18A-2, 18B is configured to perform any of the steps of any of the embodiments described above for the network node 18A-1, 18A-2, 18B.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

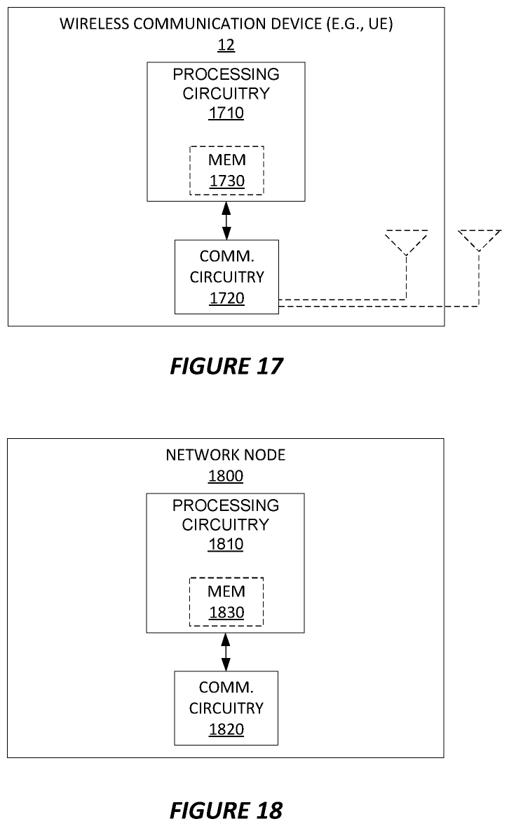

FIG. 17 for example illustrates a wireless communication device 12 as implemented in accordance with one or more embodiments. As shown, the wireless communication device 12 includes processing circuitry 1710 and communication circuitry 1720. The communication circuitry 1720 (e.g., radio circuitry) is configured to transmit and/or receive information to and/or from one or more other nodes, e.g., via any communication technology. Such communication may occur via one or more antennas that are either internal or external to the wireless communication device 12. The processing circuitry 1710 is configured to perform processing described above, e.g., in FIG. 11, such as by executing instructions stored in memory 1730. The processing circuitry 1710 in this regard may implement certain functional means, units, or modules.

FIG. 18 illustrates a network node 1800 as implemented in accordance with one or more embodiments. The network node 1800 may for instance be network node 18A-1, network node 18A-2, or network node 18B. As shown, the network node 1800 includes processing circuitry 1810 and communication circuitry 1820. The communication circuitry 1820 is configured to transmit and/or receive information to and/or from one or more other nodes, e.g., via any communication technology. The processing circuitry 1810 is configured to perform processing described above, e.g., in FIG. 12, such as by executing instructions stored in memory 1830. The processing circuitry 1810 in this regard may implement certain functional means, units, or modules.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts and/or wireless network types for illustrative purposes, but the embodiments are similarly applicable in other contexts and/or wireless network types not explicitly described.

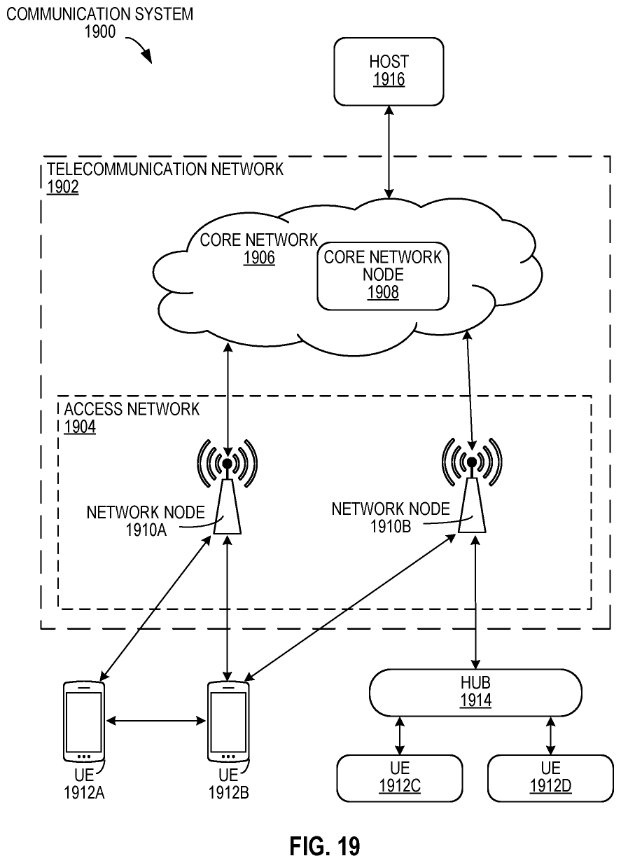

FIG. 19 shows an example of a communication system 1900 in accordance with some embodiments.

In the example, the communication system 1900 includes a telecommunication network 1902 that includes an access network 1904, such as a radio access network (RAN), and a core network 1906, which includes one or more core network nodes 1908. The access network 1904 includes one or more access network nodes, such as network nodes 1910a and 1910b (one or more of which may be generally referred to as network nodes 1910), or any other similar 3^{rd} Generation Partnership Project (3GPP) access node or non-3GPP access point. The network nodes 1910 facilitate direct or indirect connection of user equipment (UE), such as by connecting UEs 1912a, 1912b, 1912c, and 1912d (one or more of which may be generally referred to as UEs 1912) to the core network 1906 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1900 may include any number of wired or wireless networks, network nodes, UEs, and/or any other components or systems that may facilitate or participate in the communication of data and/or signals whether via wired or wireless connections. The communication system 1900 may include and/or interface with any type of communication, telecommunication, data, cellular, radio network, and/or other similar type of system.

The UEs 1912 may be any of a wide variety of communication devices, including wireless devices arranged, configured, and/or operable to communicate wirelessly with the network nodes 1910 and other communication devices. Similarly, the network nodes 1910 are arranged, capable, configured, and/or operable to communicate directly or indirectly with the UEs 1912 and/or with other network nodes or equipment in the telecommunication network 1902 to enable and/or provide network access, such as wireless network access, and/or to perform other functions, such as administration in the telecommunication network 1902.

In the depicted example, the core network 1906 connects the network nodes 1910 to one or more hosts, such as host 1916. These connections may be direct or indirect via one or more intermediary networks or devices. In other examples, network nodes may be directly coupled to hosts. The core network 1906 includes one more core network nodes (e.g., core network node 1908) that are structured with hardware and software components. Features of these components may be substantially similar to those described with respect to the UEs, network nodes, and/or hosts, such that the descriptions thereof are generally applicable to the corresponding components of the core network node 1908. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1916 may be under the ownership or control of a service provider other than an operator or provider of the access network 1904 and/or the telecommunication network 1902, and may be operated by the service provider or on behalf of the service provider. The host 1916 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1900 of FIG. 19 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WIFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1902 is a cellular network that implements 3GPP standardized features. Accordingly, the telecommunications network 1902 may support network slicing to provide different logical networks to different devices that are connected to the telecommunication network 1902. For example, the telecommunications network 1902 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1912 are configured to transmit and/or receive information without direct human interaction. For instance, a UE may be designed to transmit information to the access network 1904 on a predetermined schedule, when triggered by an internal or external event, or in response to requests from the access network 1904. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1914 communicates with the access network 1904 to facilitate indirect communication between one or more UEs (e.g., UE 1912c and/or 1912d) and network nodes (e.g., network node 1910b). In some examples, the hub 1914 may be a controller, router, content source and analytics, or any of the other communication devices described herein regarding UEs. For example, the hub 1914 may be a broadband router enabling access to the core network 1906 for the UEs. As another example, the hub 1914 may be a controller that sends commands or instructions to one or more actuators in the UEs. Commands or instructions may be received from the UEs, network nodes 1910, or by executable code, script, process, or other instructions in the hub 1914. As another example, the hub 1914 may be a data collector that acts as temporary storage for UE data and, in some embodiments, may perform analysis or other processing of the data. As another example, the hub 1914 may be a content source. For example, for a UE that is a VR headset, display, loudspeaker or other media delivery device, the hub 1914 may retrieve VR assets, video, audio, or other media or data related to sensory information via a network node, which the hub 1914 then provides to the UE either directly, after performing local processing, and/or after adding additional local content. In still another example, the hub 1914 acts as a proxy server or orchestrator for the UEs, in particular in if one or more of the UEs are low energy IoT devices.

The hub 1914 may have a constant/persistent or intermittent connection to the network node 1910b. The hub 1914 may also allow for a different communication scheme and/or schedule between the hub 1914 and UEs (e.g., UE 1912c and/or 1912d), and between the hub 1914 and the core network 1906. In other examples, the hub 1914 is connected to the core network 1906 and/or one or more UEs via a wired connection. Moreover, the hub 1914 may be configured to connect to an M2M service provider over the access network 1904 and/or to another UE over a direct connection. In some scenarios, UEs may establish a wireless connection with the network nodes 1910 while still connected via the hub 1914 via a wired or wireless connection. In some embodiments, the hub 1914 may be a dedicated hub—that is, a hub whose primary function is to route communications to/from the UEs from/to the network node 1910b. In other embodiments, the hub 1914 may be a non-dedicated hub—that is, a device which is capable of operating to route communications between the UEs and network node 1910b, but which is additionally capable of operating as a communication start and/or end point for certain data channels.

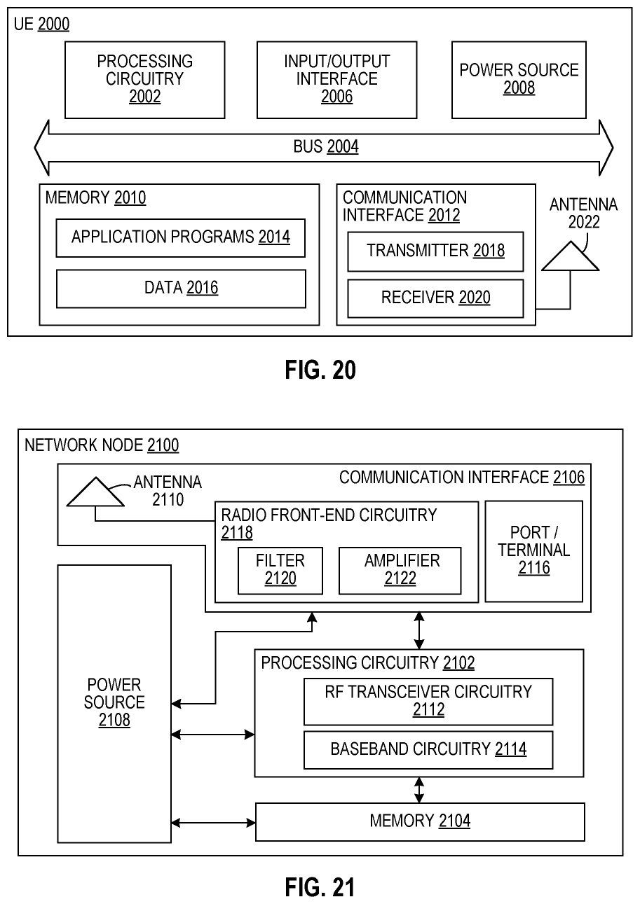

FIG. 20 shows a UE 2000 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 2000 includes processing circuitry 2002 that is operatively coupled via a bus 2004 to an input/output interface 2006, a power source 2008, a memory 2010, a communication interface 2012, and/or any other component, or any combination thereof. Certain UEs may utilize all or a subset of the components shown in FIG. 20. The level of integration between the components may vary from one UE to another UE. Further, certain UEs may contain multiple instances of a component, such as multiple processors, memories, transceivers, transmitters, receivers, etc.

The processing circuitry 2002 is configured to process instructions and data and may be configured to implement any sequential state machine operative to execute instructions stored as machine-readable computer programs in the memory 2010. The processing circuitry 2002 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 2002 may include multiple central processing units (CPUs).

In the example, the input/output interface 2006 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 2000. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 2008 is structured as a battery or battery pack. Other types of power sources, such as an external power source (e.g., an electricity outlet), photovoltaic device, or power cell, may be used. The power source 2008 may further include power circuitry for delivering power from the power source 2008 itself, and/or an external power source, to the various parts of the UE 2000 via input circuitry or an interface such as an electrical power cable. Delivering power may be, for example, for charging of the power source 2008. Power circuitry may perform any formatting, converting, or other modification to the power from the power source 2008 to make the power suitable for the respective components of the UE 2000 to which power is supplied.

The memory 2010 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 2010 includes one or more application programs 2014, such as an operating system, web browser application, a widget, gadget engine, or other application, and corresponding data 2016. The memory 2010 may store, for use by the UE 2000, any of a variety of various operating systems or combinations of operating systems.

The memory 2010 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 2010 may allow the UE 2000 to access instructions, application programs and the like, stored on transitory or non-transitory memory media, to off-load data, or to upload data. An article of manufacture, such as one utilizing a communication system may be tangibly embodied as or in the memory 2010, which may be or comprise a device-readable storage medium.

The processing circuitry 2002 may be configured to communicate with an access network or other network using the communication interface 2012. The communication interface 2012 may comprise one or more communication subsystems and may include or be communicatively coupled to an antenna 2022. The communication interface 2012 may include one or more transceivers used to communicate, such as by communicating with one or more remote transceivers of another device capable of wireless communication (e.g., another UE or a network node in an access network). Each transceiver may include a transmitter 2018 and/or a receiver 2020 appropriate to provide network communications (e.g., optical, electrical, frequency allocations, and so forth). Moreover, the transmitter 2018 and receiver 2020 may be coupled to one or more antennas (e.g., antenna 2022) and may share circuit components, software or firmware, or alternatively be implemented separately.

In the illustrated embodiment, communication functions of the communication interface 2012 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 2012, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 2000 shown in FIG. 20.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 21 shows a network node 2100 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 2100 includes a processing circuitry 2102, a memory 2104, a communication interface 2106, and a power source 2108. The network node 2100 may be composed of multiple physically separate components (e.g., a NodeB component and a RNC component, or a BTS component and a BSC component, etc.), which may each have their own respective components. In certain scenarios in which the network node 2100 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 2100 may be configured to support multiple radio access technologies (RATs). In such embodiments, some components may be duplicated (e.g., separate memory 2104 for different RATs) and some components may be reused (e.g., a same antenna 2110 may be shared by different RATs). The network node 2100 may also include multiple sets of the various illustrated components for different wireless technologies integrated into network node 2100, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 2100.

The processing circuitry 2102 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 2100 components, such as the memory 2104, to provide network node 2100 functionality.

In some embodiments, the processing circuitry 2102 includes a system on a chip (SOC). In some embodiments, the processing circuitry 2102 includes one or more of radio frequency (RF) transceiver circuitry 2112 and baseband processing circuitry 2114. In some embodiments, the radio frequency (RF) transceiver circuitry 2112 and the baseband processing circuitry 2114 may be on separate chips (or sets of chips), boards, or units, such as radio units and digital units. In alternative embodiments, part or all of RF transceiver circuitry 2112 and baseband processing circuitry 2114 may be on the same chip or set of chips, boards, or units.

The memory 2104 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 2102. The memory 2104 may store any suitable instructions, data, or information, including a computer program, software, an application including one or more of logic, rules, code, tables, and/or other instructions capable of being executed by the processing circuitry 2102 and utilized by the network node 2100. The memory 2104 may be used to store any calculations made by the processing circuitry 2102 and/or any data received via the communication interface 2106. In some embodiments, the processing circuitry 2102 and memory 2104 is integrated.

The communication interface 2106 is used in wired or wireless communication of signaling and/or data between a network node, access network, and/or UE. As illustrated, the communication interface 2106 comprises port(s)/terminal(s) 2116 to send and receive data, for example to and from a network over a wired connection. The communication interface 2106 also includes radio front-end circuitry 2118 that may be coupled to, or in certain embodiments a part of, the antenna 2110. Radio front-end circuitry 2118 comprises filters 2120 and amplifiers 2122. The radio front-end circuitry 2118 may be connected to an antenna 2110 and processing circuitry 2102. The radio front-end circuitry may be configured to condition signals communicated between antenna 2110 and processing circuitry 2102. The radio front-end circuitry 2118 may receive digital data that is to be sent out to other network nodes or UEs via a wireless connection. The radio front-end circuitry 2118 may convert the digital data into a radio signal having the appropriate channel and bandwidth parameters using a combination of filters 2120 and/or amplifiers 2122. The radio signal may then be transmitted via the antenna 2110. Similarly, when receiving data, the antenna 2110 may collect radio signals which are then converted into digital data by the radio front-end circuitry 2118. The digital data may be passed to the processing circuitry 2102. In other embodiments, the communication interface may comprise different components and/or different combinations of components.

In certain alternative embodiments, the network node 2100 does not include separate radio front-end circuitry 2118, instead, the processing circuitry 2102 includes radio front-end circuitry and is connected to the antenna 2110. Similarly, in some embodiments, all or some of the RF transceiver circuitry 2112 is part of the communication interface 2106. In still other embodiments, the communication interface 2106 includes one or more ports or terminals 2116, the radio front-end circuitry 2118, and the RF transceiver circuitry 2112, as part of a radio unit (not shown), and the communication interface 2106 communicates with the baseband processing circuitry 2114, which is part of a digital unit (not shown).

The antenna 2110 may include one or more antennas, or antenna arrays, configured to send and/or receive wireless signals. The antenna 2110 may be coupled to the radio front-end circuitry 2118 and may be any type of antenna capable of transmitting and receiving data and/or signals wirelessly. In certain embodiments, the antenna 2110 is separate from the network node 2100 and connectable to the network node 2100 through an interface or port.

The antenna 2110, communication interface 2106, and/or the processing circuitry 2102 may be configured to perform any receiving operations and/or certain obtaining operations described herein as being performed by the network node. Any information, data and/or signals may be received from a UE, another network node and/or any other network equipment. Similarly, the antenna 2110, the communication interface 2106, and/or the processing circuitry 2102 may be configured to perform any transmitting operations described herein as being performed by the network node. Any information, data and/or signals may be transmitted to a UE, another network node and/or any other network equipment.

The power source 2108 provides power to the various components of network node 2100 in a form suitable for the respective components (e.g., at a voltage and current level needed for each respective component). The power source 2108 may further comprise, or be coupled to, power management circuitry to supply the components of the network node 2100 with power for performing the functionality described herein. For example, the network node 2100 may be connectable to an external power source (e.g., the power grid, an electricity outlet) via an input circuitry or interface such as an electrical cable, whereby the external power source supplies power to power circuitry of the power source 2108. As a further example, the power source 2108 may comprise a source of power in the form of a battery or battery pack which is connected to, or integrated in, power circuitry. The battery may provide backup power should the external power source fail.

Embodiments of the network node 2100 may include additional components beyond those shown in FIG. 21 for providing certain aspects of the network node's functionality, including any of the functionality described herein and/or any functionality necessary to support the subject matter described herein. For example, the network node 2100 may include user interface equipment to allow input of information into the network node 2100 and to allow output of information from the network node 2100. This may allow a user to perform diagnostic, maintenance, repair, and other administrative functions for the network node 2100.

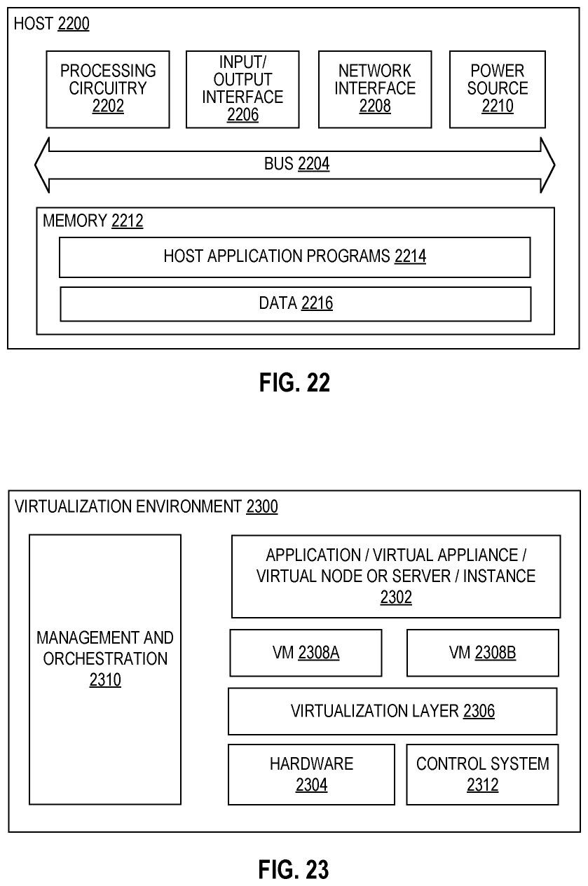

FIG. 22 is a block diagram of a host 2200, which may be an embodiment of the host 1916 of FIG. 19, in accordance with various aspects described herein. As used herein, the host 2200 may be or comprise various combinations hardware and/or software, including a standalone server, a blade server, a cloud-implemented server, a distributed server, a virtual machine, container, or processing resources in a server farm. The host 2200 may provide one or more services to one or more UEs.

The host 2200 includes processing circuitry 2202 that is operatively coupled via a bus 2204 to an input/output interface 2206, a network interface 2208, a power source 2210, and a memory 2212. Other components may be included in other embodiments. Features of these components may be substantially similar to those described with respect to the devices of previous figures, such as FIGS. 20 and 21, such that the descriptions thereof are generally applicable to the corresponding components of host 2200.

The memory 2212 may include one or more computer programs including one or more host application programs 2214 and data 2216, which may include user data, e.g., data generated by a UE for the host 2200 or data generated by the host 2200 for a UE. Embodiments of the host 2200 may utilize only a subset or all of the components shown. The host application programs 2214 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 2214 may also provide for user authentication and licensing checks and may periodically report health, routes, and content availability to a central node, such as a device in or on the edge of a core network. Accordingly, the host 2200 may select and/or indicate a different host for over-the-top services for a UE. The host application programs 2214 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 23 is a block diagram illustrating a virtualization environment 2300 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 2300 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 2302 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 2304 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 2306 (also referred to as hypervisors or virtual machine monitors (VMMs)), provide VMs 2308a and 2308b (one or more of which may be generally referred to as VMs 2308), and/or perform any of the functions, features and/or benefits described in relation with some embodiments described herein. The virtualization layer 2306 may present a virtual operating platform that appears like networking hardware to the VMs 2308.

The VMs 2308 comprise virtual processing, virtual memory, virtual networking or interface and virtual storage, and may be run by a corresponding virtualization layer 2306. Different embodiments of the instance of a virtual appliance 2302 may be implemented on one or more of VMs 2308, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 2308 may be a software implementation of a physical machine that runs programs as if they were executing on a physical, non-virtualized machine. Each of the VMs 2308, and that part of hardware 2304 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 2308 on top of the hardware 2304 and corresponds to the application 2302.

Hardware 2304 may be implemented in a standalone network node with generic or specific components. Hardware 2304 may implement some functions via virtualization. Alternatively, hardware 2304 may be part of a larger cluster of hardware (e.g. such as in a data center or CPE) where many hardware nodes work together and are managed via management and orchestration 2310, which, among others, oversees lifecycle management of applications 2302. In some embodiments, hardware 2304 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 2312 which may alternatively be used for communication between hardware nodes and radio units.

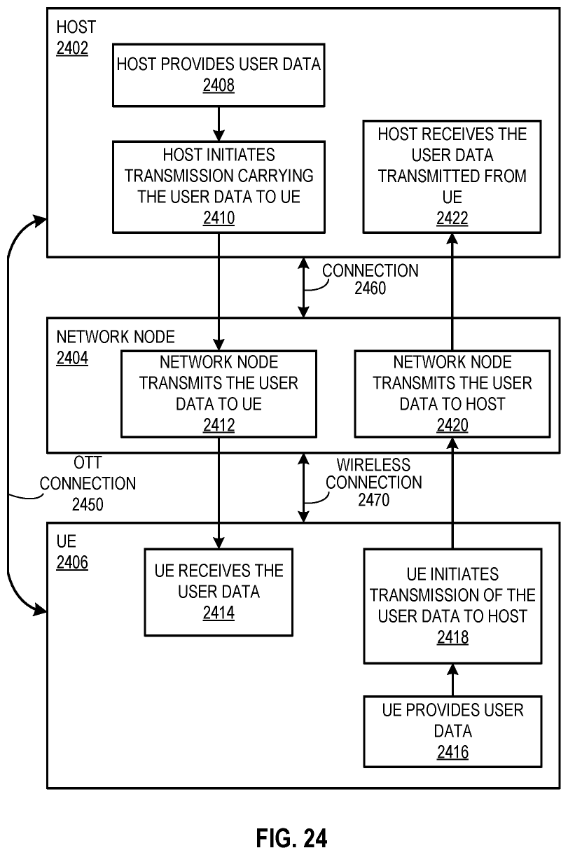

FIG. 24 shows a communication diagram of a host 2402 communicating via a network node 2404 with a UE 2406 over a partially wireless connection in accordance with some embodiments. Example implementations, in accordance with various embodiments, of the UE (such as a UE 1912a of FIG. 19 and/or UE 2000 of FIG. 20), network node (such as network node 1910a of FIG. 19 and/or network node 2100 of FIG. 21), and host (such as host 1916 of FIG. 19 and/or host 2200 of FIG. 22) discussed in the preceding paragraphs will now be described with reference to FIG. 24.

Like host 2200, embodiments of host 2402 include hardware, such as a communication interface, processing circuitry, and memory. The host 2402 also includes software, which is stored in or accessible by the host 2402 and executable by the processing circuitry. The software includes a host application that may be operable to provide a service to a remote user, such as the UE 2406 connecting via an over-the-top (OTT) connection 2450 extending between the UE 2406 and host 2402. In providing the service to the remote user, a host application may provide user data which is transmitted using the OTT connection 2450.

The network node 2404 includes hardware enabling it to communicate with the host 2402 and UE 2406. The connection 2460 may be direct or pass through a core network (like core network 1906 of FIG. 19) and/or one or more other intermediate networks, such as one or more public, private, or hosted networks. For example, an intermediate network may be a backbone network or the Internet.

The UE 2406 includes hardware and software, which is stored in or accessible by UE 2406 and executable by the UE's processing circuitry. The software includes a client application, such as a web browser or operator-specific “app” that may be operable to provide a service to a human or non-human user via UE 2406 with the support of the host 2402. In the host 2402, an executing host application may communicate with the executing client application via the OTT connection 2450 terminating at the UE 2406 and host 2402. In providing the service to the user, the UE's client application may receive request data from the host's host application and provide user data in response to the request data. The OTT connection 2450 may transfer both the request data and the user data. The UE's client application may interact with the user to generate the user data that it provides to the host application through the OTT connection 2450.

The OTT connection 2450 may extend via a connection 2460 between the host 2402 and the network node 2404 and via a wireless connection 2470 between the network node 2404 and the UE 2406 to provide the connection between the host 2402 and the UE 2406. The connection 2460 and wireless connection 2470, over which the OTT connection 2450 may be provided, have been drawn abstractly to illustrate the communication between the host 2402 and the UE 2406 via the network node 2404, without explicit reference to any intermediary devices and the precise routing of messages via these devices.

As an example of transmitting data via the OTT connection 2450, in step 2408, the host 2402 provides user data, which may be performed by executing a host application. In some embodiments, the user data is associated with a particular human user interacting with the UE 2406. In other embodiments, the user data is associated with a UE 2406 that shares data with the host 2402 without explicit human interaction. In step 2410, the host 2402 initiates a transmission carrying the user data towards the UE 2406. The host 2402 may initiate the transmission responsive to a request transmitted by the UE 2406. The request may be caused by human interaction with the UE 2406 or by operation of the client application executing on the UE 2406. The transmission may pass via the network node 2404, in accordance with the teachings of the embodiments described throughout this disclosure. Accordingly, in step 2412, the network node 2404 transmits to the UE 2406 the user data that was carried in the transmission that the host 2402 initiated, in accordance with the teachings of the embodiments described throughout this disclosure. In step 2414, the UE 2406 receives the user data carried in the transmission, which may be performed by a client application executed on the UE 2406 associated with the host application executed by the host 2402.

In some examples, the UE 2406 executes a client application which provides user data to the host 2402. The user data may be provided in reaction or response to the data received from the host 2402. Accordingly, in step 2416, the UE 2406 may provide user data, which may be performed by executing the client application. In providing the user data, the client application may further consider user input received from the user via an input/output interface of the UE 2406. Regardless of the specific manner in which the user data was provided, the UE 2406 initiates, in step 2418, transmission of the user data towards the host 2402 via the network node 2404. In step 2420, in accordance with the teachings of the embodiments described throughout this disclosure, the network node 2404 receives user data from the UE 2406 and initiates transmission of the received user data towards the host 2402. In step 2422, the host 2402 receives the user data carried in the transmission initiated by the UE 2406.

One or more of the various embodiments improve the performance of OTT services provided to the UE 2406 using the OTT connection 2450, in which the wireless connection 2470 forms the last segment.

In an example scenario, factory status information may be collected and analyzed by the host 2402. As another example, the host 2402 may process audio and video data which may have been retrieved from a UE for use in creating maps. As another example, the host 2402 may collect and analyze real-time data to assist in controlling vehicle congestion (e.g., controlling traffic lights). As another example, the host 2402 may store surveillance video uploaded by a UE. As another example, the host 2402 may store or control access to media content such as video, audio, VR or AR which it can broadcast, multicast or unicast to UEs. As other examples, the host 2402 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 2450 between the host 2402 and UE 2406, in response to variations in the measurement results. The measurement procedure and/or the network functionality for reconfiguring the OTT connection may be implemented in software and hardware of the host 2402 and/or UE 2406. In some embodiments, sensors (not shown) may be deployed in or in association with other devices through which the OTT connection 2450 passes; the sensors may participate in the measurement procedure by supplying values of the monitored quantities exemplified above, or supplying values of other physical quantities from which software may compute or estimate the monitored quantities. The reconfiguring of the OTT connection 2450 may include message format, retransmission settings, preferred routing etc.; the reconfiguring need not directly alter the operation of the network node 2404. Such procedures and functionalities may be known and practiced in the art. In certain embodiments, measurements may involve proprietary UE signaling that facilitates measurements of throughput, propagation times, latency and the like, by the host 2402. The measurements may be implemented in that software causes messages to be transmitted, in particular empty or ‘dummy’ messages, using the OTT connection 2450 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Notably, modifications and other embodiments of the disclosed disclosure will come to mind to one skilled in the art having the benefit of the teachings presented in the foregoing descriptions and the associated drawings. Therefore, it is to be understood that the present disclosure not to be limited to the specific embodiments disclosed and that modifications and other embodiments are intended to be included within the scope of this disclosure. Although specific terms may be employed herein, they are used in a generic and descriptive sense only and not for purposes of limitation.

Example embodiments of the techniques and apparatus described herein include, but are not limited to, the following enumerated examples:

### Group A Embodiments

A1. A method performed by a wireless communication device, the method comprising: transmitting, to a network node in an Evolved Packet System, EPS, signaling indicating
a capability of the wireless communication device to support user plane integrity protection over New Radio, NR, in Evolved Universal Terrestrial Radio Access-NR Dual Connectivity, EN-DC.

A2. The method of embodiment A1, wherein the signaling indicates whether the wireless communication device supports user plane integrity protection for a data radio bearer established with a secondary gNB, SgNB, in EN-DC.

A3. The method of any of embodiments A1-A2, wherein the signaling is non-access stratum, NAS, signaling.

A4. The method of any of embodiments A1-A3, wherein the network node is a Mobility Management Entity, MME.

A5. The method of any of embodiments A1-A4, wherein the signaling is transmitted in an Attach Request message, a Tracking Area Update message, a Security Mode Complete message, or a Service Request message.

A6. The method of any of embodiments A1-A2, wherein the signaling is Radio Resource Control, RRC, signaling.

A7. The method of any of embodiments A1-A2 and A6, wherein the network node is an eNB.

A8. The method of any of embodiments A1-A2 and A6-A7, wherein the network node is a master eNB in EN-DC.

A9. The method of any of embodiments A1-A2 and A6-A8, wherein the signaling is transmitted during, or as part of, a procedure for initial context setup, path switch, or handover.

A10. The method of any of embodiments A1-A9, further comprising transmitting or receiving, over NR in EN-DC, user plane data that is integrity protected in accordance with the capability indicated by the signaling.

AA. The method of any of the previous embodiments, further comprising:
providing user data; and
forwarding the user data to a host via the transmission to the network node.

### Group B Embodiments

B1. A method performed by a network node, the method comprising:
transmitting or receiving signaling indicating a capability of a wireless communication device to support user plane integrity protection over NR in EN-DC.

B2. The method of embodiment B1, wherein the signaling indicates whether the wireless communication device supports user plane integrity protection for a data radio bearer established with a secondary gNB, SgNB, in EN-DC.

B3. The method of any of embodiments B1-B2, wherein the network node is in an Evolved Packet System, EPS.

B4. The method of any of embodiments B1-B3, wherein said transmitting or receiving comprises receiving the signaling.

B5. The method of embodiment B4, wherein the signaling is received from the wireless communication device.

B6. The method of embodiment B4, wherein the signaling is received from another network node.

B7. The method of embodiment B6, wherein the network node is in an EPS and wherein the another network node is also in the EPS.

B8. The method of any of embodiments B1-B3, wherein said transmitting or receiving comprises transmitting the signaling to another network node.

B9. The method of embodiment B8, wherein the network node is in an EPS and wherein the another network node is also in the EPS.

B10. The method of embodiment B8, wherein the network node is in an EPS and wherein the another network node is in a 5G System, 5GS.

B11. The method of any of embodiments B1-B10 wherein the signaling is non-access stratum, NAS, signaling.

B12. The method of any of embodiments B1-B11, wherein the network node is a Mobility Management Entity, MME.

B13. The method of any of embodiments B1-B12, wherein the signaling is transmitted or received in an Attach Request message, a Tracking Area Update message, a Security Mode Complete message, or a Service Request message.

B14. The method of any of embodiments B1-B10, wherein the signaling is Radio Resource Control, RRC, signaling.

B15. The method of any of embodiments B1-B10 and B14, wherein the network node is an eNB.

B16. The method of any of embodiments B1-B10 and B14-B15, wherein the network node is a master eNB in EN-DC.

B17. The method of embodiment B16, wherein said transmitting or receiving comprises transmitting the signaling.

B18. The method of embodiment B17, further comprising creating the capability responsive to failure to receive NR security capabilities for the wireless communication device from a Mobility Management Entity, MME.

B19. The method of embodiment B18, wherein said creating comprises mapping Bit 128-EIA4, 128-EIA5, or 128-EIA6 in a UE Network Capability IE as said capability.

B20. The method of any of embodiments B1-B10 and B14-B16, wherein the signaling is received during, or as part of, a procedure for initial context setup, path switch, or handover.

B21. The method of any of embodiments B1-B20, wherein the signaling is transmitted or received during, or as part of, a procedure for requesting the addition of an SgNB for EN-DC.

B22. The method of any of embodiments B1-B10 and B17-B18, wherein the network node is a secondary gNB for EN-DC.

B23. The method of embodiment B22, further comprising activating or deactivating user plane integrity protection over NR in EN-DC based on the capability indicated by the signaling.

B24. The method of embodiment B23, wherein said activating or deactivating is also based on a user plane integrity protection policy received from a master eNB in EN-DC.

B25. The method of embodiment B23, wherein said activating or deactivating is also based on a local policy that is pre-configured at the network node and that governs user plane integrity protection over NR in EN-DC, wherein the local policy controls activation or deactivation of user plane integrity protection over NR in EN-DC if no user plane integrity protection policy is received from a master eNB in EN-DC.

BB. The method of any of the previous embodiments, further comprising:
obtaining user data; and
forwarding the user data to a host or a user equipment.

### Group X Embodiments

X1. A method performed by a secondary eNB, SeNB, for Dual Connectivity, DC, in an Evolved Packet System, EPS, the method comprising:
receiving EPS security capabilities for a wireless communication device;
determining, from the EPS security capabilities, whether the wireless communication device supports user plane integrity protection with an eNB connected to the EPS; and
responsive to determining that the wireless communication device supports user plane integrity protection with an eNB connected to the EPS, either:
   using a user plane integrity protection policy from a master eNB to determine whether to activate or deactivate user plane integrity protection in DC; or
   using a local policy that is pre-configured at the SeNB to determine whether to activate or deactivate user plane integrity protection in DC, wherein the local policy controls activation or deactivation of user plane integrity protection in DC if no user plane integrity protection policy is received from the master eNB in DC.

X2. The method of embodiment X1, wherein said using comprises using a user plane integrity protection policy from a master eNB to determine whether to activate or deactivate user plane integrity protection in DC.

X3. The method of embodiment X1, wherein said using comprises using a local policy that is pre-configured at the SeNB to determine whether to activate or deactivate user plane integrity protection in DC, wherein the local policy controls activation or deactivation of user plane integrity protection in DC if no user plane integrity protection policy is received from the master eNB in DC.

### Group C Embodiments

C1. A wireless communication device configured to perform any of the steps of any of the Group A embodiments.

C2. A wireless communication device comprising processing circuitry configured to perform any of the steps of any of the Group A embodiments.

C3. A wireless communication device comprising:
communication circuitry; and processing circuitry configured to perform any of the steps of any of the Group A embodiments.

C4. A wireless communication device comprising:
processing circuitry configured to perform any of the steps of any of the Group A embodiments; and
power supply circuitry configured to supply power to the wireless communication device.

C5. A wireless communication device comprising:
processing circuitry and memory, the memory containing instructions executable by the processing circuitry whereby the wireless communication device is configured to perform any of the steps of any of the Group A embodiments.

C6. A user equipment (UE) comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

C7. A computer program comprising instructions which, when executed by at least one processor of a wireless communication device, causes the wireless communication device to carry out the steps of any of the Group A embodiments.

C8. A carrier containing the computer program of embodiment C7, wherein the carrier is one of an electronic signal, optical signal, radio signal, or computer readable storage medium.

C9. A network node configured to perform any of the steps of any of the Group B embodiments.

C10. A network node comprising processing circuitry configured to perform any of the steps of any of the Group B embodiments.

C11. A network node comprising:
communication circuitry; and
processing circuitry configured to perform any of the steps of any of the Group B embodiments.

C12. A network node comprising:
processing circuitry configured to perform any of the steps of any of the Group B embodiments;
power supply circuitry configured to supply power to the network node.

C13. A network node comprising:
processing circuitry and memory, the memory containing instructions executable by the processing circuitry whereby the network node is configured to perform any of the steps of any of the Group B embodiments.

C14. The network node of any of embodiments C9-C13, wherein the network node is a base station.

C15. A computer program comprising instructions which, when executed by at least one processor of a network node, causes the network node to carry out the steps of any of the Group B embodiments.

C16. The computer program of embodiment C14, wherein the network node is a base station.

C17. A carrier containing the computer program of any of embodiments C15-C16, wherein the carrier is one of an electronic signal, optical signal, radio signal, or computer readable storage medium.

### Group D Embodiments

D1. A communication system including a host computer comprising:
processing circuitry configured to provide user data; and
a communication interface configured to forward the user data to a cellular network for transmission to a user equipment (UE),
wherein the cellular network comprises a base station having a radio interface and processing circuitry, the base station's processing circuitry configured to perform any of the steps of any of the Group B embodiments.

D2. The communication system of the previous embodiment further including the base station.

D3. The communication system of the previous 2 embodiments, further including the UE, wherein the UE is configured to communicate with the base station.

D4. The communication system of the previous 3 embodiments, wherein:
the processing circuitry of the host computer is configured to execute a host application, thereby providing the user data; and
the UE comprises processing circuitry configured to execute a client application associated with the host application.

D5. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station performs any of the steps of any of the Group B embodiments.

D6. The method of the previous embodiment, further comprising, at the base station, transmitting the user data.

D7. The method of the previous 2 embodiments, wherein the user data is provided at the host computer by executing a host application, the method further comprising, at the UE, executing a client application associated with the host application.

D8. A user equipment (UE) configured to communicate with a base station, the UE comprising a radio interface and processing circuitry configured to perform any of the previous 3 embodiments.

D9. A communication system including a host computer comprising:
processing circuitry configured to provide user data; and
a communication interface configured to forward user data to a cellular network for transmission to a user equipment (UE),
wherein the UE comprises a radio interface and processing circuitry, the UE's components configured to perform any of the steps of any of the Group A embodiments.

D10. The communication system of the previous embodiment, wherein the cellular network further includes a base station configured to communicate with the UE.

D11. The communication system of the previous 2 embodiments, wherein:
the processing circuitry of the host computer is configured to execute a host application, thereby providing the user data; and
the UE's processing circuitry is configured to execute a client application associated with the host application.

D12. A method implemented in a communication system including a host computer, a base station and a user equipment (UE), the method comprising:
at the host computer, providing user data; and
at the host computer, initiating a transmission carrying the user data to the UE via a cellular network comprising the base station, wherein the UE performs any of the steps of any of the Group A embodiments.

D13. The method of the previous embodiment, further comprising at the UE, receiving the user data from the base station.

D14. A communication system including a host computer comprising:
communication interface configured to receive user data originating from a transmission from a user equipment (UE) to a base station,
wherein the UE comprises a radio interface and processing circuitry, the UE's processing circuitry configured to perform any of the steps of any of the Group A embodiments.

D15. The communication system of the previous embodiment, further including the UE.

D16. The communication system of the previous 2 embodiments, further including the base station, wherein the base station comprises a radio interface configured to communicate with the UE and a communication interface configured to forward to the host computer the user data carried by a transmission from the UE to the base station.

D17. The communication system of the previous 3 embodiments, wherein:
the processing circuitry of the host computer is configured to execute a host application; and
the UE's processing circuitry is configured to execute a client application associated with the host application, thereby providing the user data.

D18. The communication system of the previous 4 embodiments, wherein:
the processing circuitry of the host computer is configured to execute a host application, thereby providing request data; and
the UE's processing circuitry is configured to execute a client application associated with the host application, thereby providing the user data in response to the request data.

D19. A method implemented in a communication system including a host computer, a base station and a user equipment (UE), the method comprising:
at the host computer, receiving user data transmitted to the base station from the UE, wherein the UE performs any of the steps of any of the Group A embodiments.

D20. The method of the previous embodiment, further comprising, at the UE, providing the user data to the base station.

D21. The method of the previous 2 embodiments, further comprising:
at the UE, executing a client application, thereby providing the user data to be transmitted; and
at the host computer, executing a host application associated with the client application.

D22. The method of the previous 3 embodiments, further comprising:
at the UE, executing a client application; and
at the UE, receiving input data to the client application, the input data being provided at the host computer by executing a host application associated with the client application,
wherein the user data to be transmitted is provided by the client application in response to the input data.

D23. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.

D24. The communication system of the previous embodiment further including the base station.

D25. The communication system of the previous 2 embodiments, further including the UE, wherein the UE is configured to communicate with the base station.

D26. The communication system of the previous 3 embodiments, wherein:
the processing circuitry of the host computer is configured to execute a host application;
the UE is configured to execute a client application associated with the host application, thereby providing the user data to be received by the host computer.

D27. A method implemented in a communication system including a host computer, a base station and a user equipment (UE), the method comprising:
at the host computer, receiving, from the base station, user data originating from a transmission which the base station has received from the UE, wherein the UE performs any of the steps of any of the Group A embodiments.

D28. The method of the previous embodiment, further comprising at the base station, receiving the user data from the UE.

D29. The method of the previous 2 embodiments, further comprising at the base station, initiating a transmission of the received user data to the host computer.

1.-24. (canceled)

25. A method performed by a wireless communication device, the method comprising:
transmitting, to a network node in an Evolved Packet System (EPS), signaling indicating a capability of the wireless communication device to support user plane integrity protection over New Radio (NR) in Evolved Universal Terrestrial Radio Access-NR Dual Connectivity (EN-DC).

26. The method of claim 25, wherein the signaling is non-access stratum (NAS) signaling or Radio Resource Control (RRC) signaling.

27. The method of claim 25, wherein the network node is a Mobility Management Entity (MME), an eNB, or a master eNB in EN-DC.

28. The method of claim 25, wherein the signaling is transmitted:
in an Attach Request message, a Tracking Area Update message, a Security Mode Complete message, or a Service Request message; and/or
during, or as part of, a procedure for initial context setup, path switch, or handover.

29. The method of claim 25, further comprising transmitting or receiving, over NR in EN-DC, user plane data that is integrity protected in accordance with the capability indicated by the signaling.

30. A method performed by a network node, the method comprising:
transmitting or receiving signaling indicating a capability of a wireless communication device to support user plane integrity protection over NR in EN-DC.

31. The method of claim 30, wherein the signaling is non-access stratum (NAS) signaling or Radio Resource Control (RRC) signaling.

32. The method of claim 30, wherein the signaling is transmitted or received in an Attach Request message, a Tracking Area Update message, a Security Mode Complete message, or a Service Request message.

33. The method of claim 30, wherein the signaling is received during, or as part of:
a procedure for initial context setup, path switch, or handover; or
a procedure for requesting the addition of an SgNB for EN-DC.

34. The method of claim 30, wherein the network node is an eNB or a Mobility Management Entity (MME).

35. The method of claim 30, wherein said transmitting or receiving comprises receiving the signaling from the wireless communication device.

36. The method of claim 30, wherein said transmitting or receiving comprises transmitting the signaling to another network node, wherein the network node is in an EPS and wherein the another network node is either in the EPS or in a 5G System (5GS).

37. The method of claim 30, wherein the network node is a secondary gNB for EN-DC, and wherein the method further comprises activating or deactivating user plane integrity protection over NR in EN-DC based on the capability indicated by the signaling.

38. A wireless communication device comprising:
communication circuitry; and
processing circuitry configured to transmit, to a network node in an Evolved Packet System (EPS) signaling indicating a capability of the wireless communication device to support user plane integrity protection over New Radio (NR) in Evolved Universal Terrestrial Radio Access-NR Dual Connectivity (EN-DC).

39. The wireless communication device of claim 38, wherein the signaling is non-access stratum (NAS) signaling or Radio Resource Control (RRC) signaling.

40. The wireless communication device of claim 38, wherein the network node is a Mobility Management Entity (MME), an eNB, or a master eNB in EN-DC.

41. The wireless communication device of claim 38, wherein the signaling is transmitted:
in an Attach Request message, a Tracking Area Update message, a Security Mode Complete message, or a Service Request message; and/or
during, or as part of, a procedure for initial context setup, path switch, or handover.

42. The wireless communication device of claim 38, wherein the processing circuitry is further configured to transmit or receive, over NR in EN-DC, user plane data that is integrity protected in accordance with the capability indicated by the signaling.

43. A network node comprising:
communication circuitry; and
processing circuitry configured to transmit or receive signaling indicating a capability of a wireless communication device to support user plane integrity protection over NR in EN-DC.

44. The network node of claim 43, wherein the signaling is non-access stratum (NAS) signaling or Radio Resource Control (RRC) signaling.

45. The network node of claim 43, wherein the processing circuitry is configured to transmit or receive the signaling in an Attach Request message, a Tracking Area Update message, a Security Mode Complete message, or a Service Request message.

46. The network node of claim 43, wherein the processing circuitry is configured to receive the signaling during, or as part of:
a procedure for initial context setup, path switch, or handover; or
a procedure for requesting the addition of an SgNB for EN-DC.

47. The network node of claim 43, wherein the network node is an eNB or a Mobility Management Entity (MME).

48. The network node of claim 43, wherein the processing circuitry is configured to receive the signaling from the wireless communication device.

49. The network node of claim 43, wherein the processing circuitry is configured to transmit the signaling to another network node, wherein the network node is in an EPS and wherein the another network node is either in the EPS or in a 5G System (5GS).

50. The network node of claim 43, wherein the network node is a secondary gNB for EN-DC, and wherein the processing circuitry is further configured to activate or deactivate user plane integrity protection over NR in EN-DC based on the capability indicated by the signaling.
